(19) United States
(12) Patent Application Publication
(10) Pub. No.: US 2003/0030342 A1
(43) Pub. Date: Feb. 13, 2003

(54) Contactless energy transfer apparatus

(76) Inventors: James C. Chen, Bellevue, WA (US); Darrin Huston, Enumclaw, WA (US); Brian D. Wilkerson, Issaquah, WA (US)

Correspondence Address: LAW OFFICES OF RONALD M ANDERSON, 600 108TH AVE, NE, SUITE 507, BELLEVUE, WA, 98004, US

(21) Appl. No.: 10/021,891

(22) Filed: Dec. 13, 2001

Related U.S. Application Data
(63) Continuation-in-part of application No. 09/547,700, filed on Apr. 11, 2000, now Pat. No. 6,331,744.
Application No. 09/547,700 is a continuation-in-part of application No. 09/325,022, filed on Jun. 3, 1999, now Pat. No. 6,092,531.
Application No. 09/325,022 is a division of application No. 09/021,693, filed on Feb. 10, 1998, now Pat. No. 5,945,762.

(51) Int. Cl. H02K 49/00; H02P 15/00; H02K 51/00

(52) U.S. Cl. 310/102 R; 310/40 MM

(57) ABSTRACT

A flux generator base unit electromagnetically couples with a portable device to transfer energy into the portable device. The base unit includes one or more permanent magnets or flux shunts that are moved (e.g., by a motor) to produce a magnetic flux coupled to a receiver coil of the portable device. The receiver coil is disposed in an elongate housing and is electrically connected with the portable device. The disposition of the elongate housing ensures that magnetic flux directed to the receiver coil generally does not affect electronic components within the portable device. Either the permanent magnet(s) or flux shunt(s) are moved within the base unit to produce the varying magnetic flux that is coupled to the receiver coil. Preferably, the receiver coil is combined with any antenna employed by the portable device.

### RELATED APPLICATIONS

This application is a continuation-in-part of U.S. patent application Ser. No. 09/547,700, filed Apr. 11, 2000, which is a continuation-in-part of U.S. patent application Ser. No. 09/325,022, filed Jun. 3, 1999, which is a divisional of U.S. patent application Ser. No. 09/021,693, filed on Feb. 10, 1998, the benefit of the filing dates of which is hereby claimed under 35 U.S.C. § 120.

### FIELD OF THE INVENTION

The present invention generally pertains to contactless transfer of electrical energy, and more specifically, to the contactless transfer of electromagnetic energy between disparate devices by moving a magnet in one of the devices to vary a magnetic flux experienced by the other device.

### BACKGROUND OF THE INVENTION

Many of today's portable consumer devices, including palm-sized computers, games, flashlights, shavers, radios, CD players, phones, power tools, small appliances, tooth brushes, etc., are powered by replaceable or rechargeable batteries. The batteries in these devices, which are typically of the nickel-cadmium, lead-acid, nickel-metal-hydride, or lithium-ion type, must be replaced or recharged periodically to enable the continued use of the devices. Considerable cost savings can be achieved by employing rechargeable batteries instead of replaceable batteries in these devices, since although the initial cost of the rechargeable batteries may be greater, over the life of the device, the total cost for replacement batteries will be much higher.

There are several methods used in the prior art to recharge batteries in portable devices. For example, many manufacturers produce rechargeable batteries corresponding to conventional AAA, AA, A, B, C, and D sizes, which are typically recharged using a charger station that is adapted to charge a certain size battery or a plurality of different size batteries. In addition, many power tool manufacturers produce lines of portable tools energized by batteries that are not of the standard sizes listed above, but which often share a common form factor and voltage rating. These specialized batteries are typically recharged by removing the battery (or battery pack) from the tool and charging it in a charger having a configuration that is specific to that manufacturer's line of tools and specifically designed to recharge batteries of that voltage. In order to recharge both conventional size batteries and the more specialized portable power tool batteries, it is generally necessary to remove the batteries from the portable device and attach them to their respective chargers. After they are recharged, the batteries must be reinstalled in the portable device. This task is unduly burdensome and time-consuming for the user.

In order to avoid the burden associated with the foregoing task, some portable consumer devices include a charge-conditioning circuit (either internally or externally) that can be used with a conventional alternating current (AC) power source, such as a wall outlet, and which includes electronic circuitry to provide a conditioned direct current (DC) at a voltage suitable for recharging a battery contained in the device. For example, it is common for electric shavers to include a charge-conditioning circuit that enables a nickel-cadmium (or other type) battery retained in the shaver to be recharged by plugging a cord removably connected to the shaver into an AC line voltage outlet. Similarly, some flashlights have an integrated connector that allows them to be recharged by simply plugging the integrated connector into an AC line wall outlet. In addition, certain devices, such as portable handheld vacuum cleaners use a “base” charger unit for both storing the device between uses and recharging the battery. When the portable device is stored in the base unit, exposed terminals on the device are connected through contacts on the base unit to a brick-type power supply energized with AC line, to provide a conditioned DC current that charges the battery integrally contained within the portable device.

In all of the foregoing examples, as is true of the majority of devices that use rechargeable batteries, some sort of interface with a charging station that includes an electrical connection (i.e., a contact) is used to provide an appropriate DC voltage for recharging the batteries. However, the use of contacts to connect a battery to a recharging current is undesirable, as they are susceptible to breakage, corrosion, and may present a potential safety hazard if used improperly or inadvertently shorted. The shape and configuration of these contacts are also generally unique to specific devices, or a manufacturer's product line, making it impractical to provide a “universal” charging interface that includes contacts for several different types of devices or devices that are produced by different manufacturers.

Recognizing the problems with recharging batteries using current supplied through electrical contacts, several manufacturers of portable products now offer “contactless” battery-charging stations. These charging stations are generally of two types: inductive charging systems, and infrared charging systems. Inductive charging systems include an electromagnetic or radio frequency (RF) coil that generates an electromagnetic field, which is coupled to a receiver coil within the device that includes a battery requiring recharging. For use in recharging a battery in one popular handheld powered toothbrush, a relatively high-frequency AC current is supplied to a transmitter coil disposed in a base used to store the handheld toothbrush. The current flowing through the transmitter coil produces a varying magnetic field at a corresponding frequency, which is inductively coupled to a receiver coil in the toothbrush housing, to generate a battery charging current. Another example of such a system is the IBC-131 contactless inductive charging system by TDK Corporation, which switches a nominal 141 volt, 20 mA (maximum) input current to a transmitter coil at 125 kHz to produce a 5 volt DC output at 130 mA in a receiver coil.

A different contactless system for charging batteries is an infrared charging system employing a light source as a transmitter and a photocell as a receiver. Energy is transferred from the source to the receiving photocell via light rather than through a magnetic field.

Both inductive and infrared charging systems have drawbacks. Notably, each system is characterized by relatively high-energy losses, resulting in low efficiencies and the generation of excessive heat, which may pose an undesirable safety hazard. Additionally, the transmitter and receiver of an inductive charging system generally must be placed in close proximity to one another, e.g., with the portable device seated in a well provided in the base. In the above-referenced TDK system, the maximum gap between the receiver and transmitter is 4 mm. Furthermore, in an infrared system, the light source and/or photocell is typically protected by a translucent material such as a clear plastic. Such protection is typically required if an infrared charging system is used in a portable device, and may potentially affect the aesthetics, functionality, and/or durability of the device. It should also be noted that inductive coupling energy transfer systems that employ RF signals often interfere with other electronic devices due to the radio frequency interference (RFI) they produce.

It would therefore be desirable to provide a contactless energy transfer apparatus suitable for use with portable consumer devices, and other devices employing a rechargeable energy storage system, that allows a greater spacing between the transmitter and receiver elements, and provides improved efficiency over the prior art. Furthermore, it is preferable that such an apparatus provide a contactless interface that requires few, if any additional specialized components to be incorporated into such a device to enable contactless energy transfer to be achieved.

### SUMMARY OF THE INVENTION

In accord with the present invention, an energy transfer apparatus is defined that is adapted for magnetically exciting a receiver coil that includes a core of a magnetically permeable material, by causing an electrical current to flow in the receiver coil. The energy transfer apparatus includes a magnetic field generator that is enclosed in a housing that forms a base unit, and includes at least one permanent magnet. The base unit housing is adapted to be disposed proximate a receiver unit housing in which the receiver coil is disposed. The base unit housing has a cradle portion adapted to support a main body portion of the receiver unit housing, and a charging portion adapted to couple a varying magnetic field to the receiver coil. The receiver coil is disposed within a receiver coil housing, which is either integral to the main body portion of the receiver unit housing, or separate from the main body portion of the receiver unit housing. The receiver coil housing extends outwardly and away from the main body portion of the receiver unit housing, such that a varying magnetic field directed toward the receiver coil housing does not substantially overlap the main body portion of the receiver unit housing. Preferably, the receiver coil housing is elongate in shape, and the charging portion of the base unit housing comprises a corresponding elongate depression into which the receiver coil housing is inserted. Most preferably, the receiver unit comprises a portable electronic device equipped with an antenna, and the receiver coil is disposed within the antenna housing attached to the portable electronic device.

A prime mover is drivingly coupled to the magnetic field generator, and when energized, causes an element of the magnetic field generator to move relative to the base unit housing. Movement of the element produces a varying magnetic field that electromagnetically couples with the core of the receiver coil and induces an electrical current to flow in the receiver coil. The prime mover of the energy transfer apparatus preferably comprises an electric motor, but can include other types of devices capable of moving the element. For example, a hand crank can be employed for moving the element. In one form of the invention, the prime mover is disposed within the base unit housing in which the magnetic field generator is enclosed. Alternatively, the prime mover is disposed remote from the magnetic field generator and is coupled to the magnetic field generator through a drive shaft passing through the base unit housing.

In several embodiments of the invention, the prime mover moves the permanent magnet relative to the receiver coil. Movement of the permanent magnet varies a magnetic flux along a path that includes the receiver coil. Increasing a speed at which the permanent magnet is moved increases a frequency of the electrical current induced in the receiver coil.

In one embodiment, the permanent magnet is reciprocated back and forth relative to the receiver coil. The reciprocating movement of the permanent magnet varies a magnetic flux along a path that includes the receiver coil.

In at least one embodiment, a flux linkage bar formed of a magnetically permeable material is preferably disposed adjacent a magnetic pole of the permanent magnet. The flux linkage bar enhances the coupling of magnetic flux from a pole of the permanent magnet into a path that includes the receiver coil.

In several embodiments, the magnetic field generator preferably comprises a plurality of permanent magnets. An adjustment member is included to selectively vary a maximum magnetic flux produced by the magnetic field generator for coupling with the receiver coil. A speed control is used as the adjustment member in one embodiment.

In another embodiment, the permanent magnets include a driven permanent magnet that is moved by the prime mover, and a “follower” permanent magnet that is magnetically coupled to the driven permanent magnet and is moved by its motion.

In yet another embodiment, the permanent magnets are fixed relative to the base unit housing, and the moving element comprises a flux shunt that is moved by the prime mover to intermittently pass adjacent to pole faces of the plurality of permanent magnets so as to intermittently provide a magnetic flux linkage path between the pole faces that effectively shunts the magnetic flux. When the magnetic flux is thus shunted, substantially less magnetic flux couples to the receiver coil. The shunting of the magnetic flux through the moving element effectively periodically “shuts off” (or at least substantially reduces) the magnetic field experienced by the receiving coil, producing the varying magnetic field.

A further technique for adjusting the maximum magnetic field employs a plurality of turns of a conductor that are wound around each of the plurality of permanent magnets. The plurality of turns of the conductor are connected to a source of an electrical current, producing a magnetic field that either opposes or aids the magnetic field produced by the permanent magnets, thereby varying the magnetic field experienced by the receiver coil.

In yet another embodiment, the permanent magnets are radially movable relative to an axis of a drive shaft that is rotatably driven by the prime mover. The permanent magnets are attracted to each other when the shaft is at rest, but an actuator moves the permanent magnets away from each other to improve the coupling of the magnetic flux with the receiver coil when the shaft is rotating. The disposition of the permanent magnets adjacent to each other when the shaft begins to rotate reduces the startup torque required to rotate the shaft. Furthermore, by enabling control of the radial disposition of the permanent magnets, the magnitude of the electrical current induced in the receiver coil is selectively controlled.

According to further aspects of the invention, a contactless battery charger/energy transfer apparatus is defined that uses the energy transfer approach described above in combination with a conditioning circuit to recharge a rechargeable storage battery disposed in a portable device. Additionally, the energy can be supplied to electronic components in the portable device (i.e., not necessarily to a battery). The contactless battery charger/energy transfer apparatus typically includes a flux generator base unit, and a receiver unit. The flux generator is housed in the flux generator base unit, which in several embodiments, preferably includes a “universal” mount configuration that enables the base unit to be used with receiver units of different sizes. The receiver unit comprises a receiver coil disposed in a housing adapted to mate with the base unit, and a conditioning circuit that conditions the current generated by the energy inductively coupled into the receiver coil to charge a battery (or batteries) and/or to provide a conditioned current to other types of electronic components in the portable device. The receiver coil housing is optionally integral to the portable device in which the receiver coil is disposed or may be a separate component that is suitable for attachment to a variety of different devices. The receiver coil housing extends outwardly and away from the main body portion of the receiver unit housing, such that a varying magnetic field directed toward the receiver coil housing does not substantially overlap the main body portion of the receiver unit housing.

In one preferred embodiment, the conditioning circuit also includes a detection circuit for determining when a battery is fully charged, and controls the charge current supplied to the battery as a function of its charge state. Also included in the flux generator base unit is a detection circuit for determining when the battery is charged, so that the motor is then turned de-energized.

According to another aspect of the invention, a wireless communication channel is effected between the receiver unit and the flux generator base unit by pulsing a load applied to the output of the conditioning circuit, thereby producing a corresponding pulse change in the current supplied to the electric motor. The pulsing current drawn by the electric motor is detected to recover the data transmitted from the receiver unit.

Another aspect of the present invention is directed to a method for charging a battery via a varying magnetic field that is inductively coupled to transfer energy to a receiver coil. The steps of this method are generally consistent with the functions provided by the elements of the apparatus discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1A is a plan view of a portable device, e.g., a cell phone, having a rechargeable battery that can be recharged using the present invention;

FIG. 1B is a plan view illustrating the portable device of FIG. 1A inserted into a flux generator base that couples a varying electromagnetic flux into a receiver coil of the portable device, in accord with the present invention;

FIG. 2 illustrates a cross-sectional elevational view of a flux generator base and a portable device showing how magnetic flux is directed towards an elongate charging portion of the portable device and away from the main body portion;

FIG. 3 is an enlarged portion of FIG. 2;

FIG. 4A is a cross-sectional view taken along section line A-A in FIG. 3, illustrating a first permanent magnet orientation;

FIG. 4B is a cross-sectional view taken along section line A-A in FIG. 3, illustrating a second permanent magnet orientation;

FIG. 4C is the enlarged portion shown in FIG. 3 illustrating a third permanent magnet orientation;

FIG. 4D is the enlarged portion shown in FIG. 3 illustrating a fourth permanent magnet orientation;

FIG. 5 is a block diagram illustrating the primary components of the present invention;

FIG. 6 is a cross-sectional view of a second embodiment of a flux generator base for coupling a varying electromagnetic flux into a receiver coil in a portable device, in accord with the present invention;

FIGS. 7A and 7B respectively illustrate a cross section elevational view and a bottom view of a third embodiment of a flux generator base that includes two sets of permanent magnets;

FIG. 7C is an isometric bottom view of a driven disk for the flux generator;

FIGS. 7D and 7D′ are respectively a bottom view of the driven disk, with two permanent magnets, and a graph of related magnetic field intensity waveforms vs. time;

FIGS. 7E and 7E′ are respectively a bottom view of the driven disk, with four permanent magnets, and a graph of related magnetic field intensity waveforms vs. time;

FIGS. 7F and 7F′ are respectively a bottom view of the driven disk, with six alternating pole permanent magnets, and a graph of related magnetic field intensity waveforms vs. time;

FIGS. 7G and 7G′ are respectively a bottom view of the driven disk, with six permanent magnets in an arrangement with three consecutive south pole faces and three consecutive north pole faces on the bottom of the drive disk, and a graph of related magnetic field intensity waveforms vs. time;

FIGS. 7H and 7H′ are respectively a bottom view of a driven disk including a pair of arcuate-shaped permanent magnets, and a graph of related magnetic field intensity waveforms vs. time;

FIGS. 8A and 8B are respectively a side elevation cross-sectional view of another embodiment of a flux generator base coupled to a receiver coil in which a rotating permanent magnet produces a magnetic flux that is coupled to the receiver coil by two flux linkage bars, and a cross-sectional view of the flux generator base taken along section lines 8B-8B in FIG. 8A;

FIG. 9 is a side cross section elevational view of another embodiment of the flux generator base and the receiver coil, in which a drive wheel rotates two permanent magnets;

FIGS. 10A and 10B are respectively a cross-sectional view of yet another embodiment of the flux generator base and the receiver coil in which one permanent magnet is directly driven to rotate and another permanent magnet magnetically follows the rotation of the driven permanent magnet, and an enlarged view of the following permanent magnet;

FIGS. 11A and 11B show a flux generator base in which two permanent magnets are driven to reciprocate back and forth above the receiver coil;

FIG. 12 is a side elevational view of a flux generator base (only a portion of the housing shown) in which three permanent magnets are to linearly reciprocate below the receiver coil;

FIG. 13 is a side elevational view of a flux generator base (only a portion of the housing shown) in which conductors coiled around two permanent magnets selectively vary a magnetic field produced by the permanent magnets;

FIG. 14 is a side elevational view of a flux generator base (only a portion of the housing shown) in which two rotating flux linkage tabs vary the magnetic flux linked between two fixed permanent magnets to the receiver coil;

FIGS. 15 and 15′ are respectively an isometric view of a flux generator base (housing not shown) in which fixed permanent magnets and a rotating flux shunt bar are provided, and a graph of the current pulses vs. time produced in the receiver coil;

FIG. 16 is a side elevational view of the receiver coil and a flux generator base (only a portion of the housing shown) in which two permanent magnets are slidably supported within a rotating tube so as to minimize starting torque, and thus reduce an external magnetic field (outside the housing) when the permanent magnets are not rotating;

FIGS. 17A and 17B are internal power heads in which a force is applied by a solenoid coil/ring magnet, and by a fluid cylinder, respectively, to two permanent magnets that are slidably mounted in a rotating tube so as to minimize starting torque, and so as to reduce an external magnetic field (outside the housing) when the permanent magnets are not rotating;

FIG. 18 is a cutaway side elevational view of yet another flux generator base including a speed control and a permanent magnet that is drivingly rotated within a plane, which is generally transverse to the plane of an internal air core receiver coil disposed within the portable apparatus to be charged;

FIGS. 19A and 19B are respectively an elevational view and plan view of a universal charger base implementation of the present invention;

FIG. 20 shows an optional embodiment of the universal charger base of FIGS. 19A and 19B wherein a pair of flux-generating bars are moved in a linear motion;

FIG. 21 shows an alternative embodiment of the universal charger base of FIGS. 19A and 19B wherein a pair of flux-generating bars are moved in an elliptical motion; and

FIGS. 22A and 22B are respectively a plan view and a cutaway side elevational view of a charger base with a plurality of cradle portions;

FIG. 23 is a plan view of another embodiment of a charger base; and

FIG. 24 is a plan view of a universal charger base that includes a plurality of relatively larger cradle portions, each cradle position having more than one charger portion associated with it.

### DESCRIPTION OF THE PREFERRED EMBODIMENT

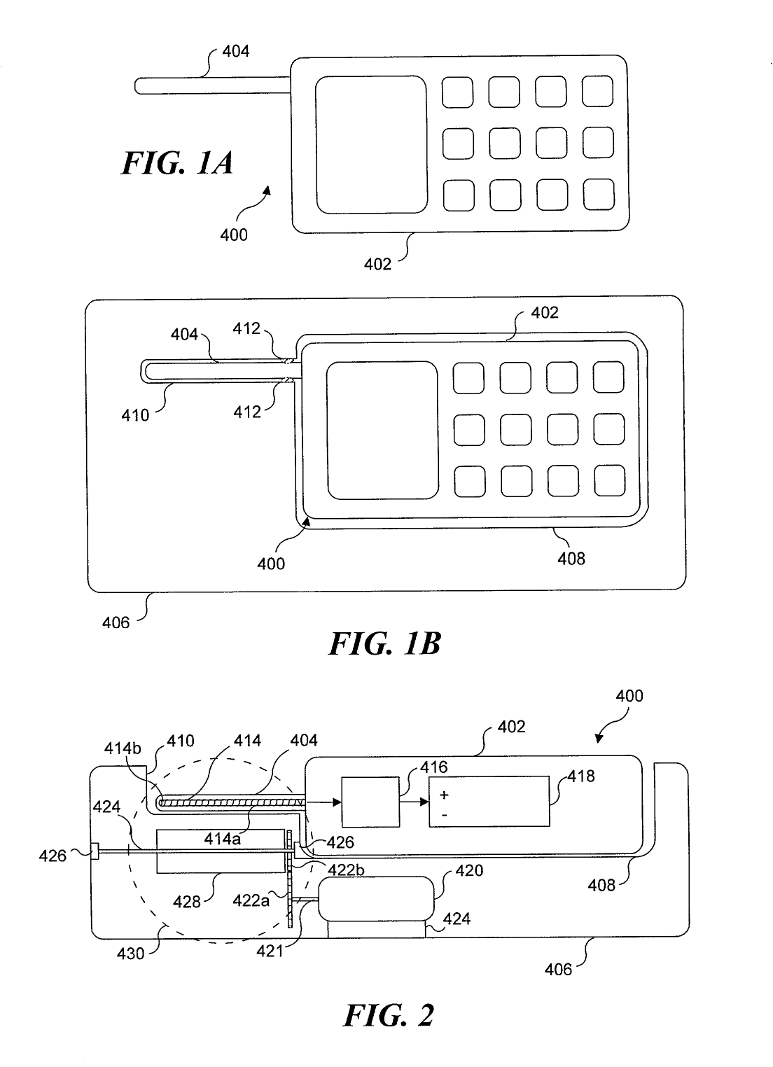

FIG. 1A illustrates a plan view of a portable electronic device 400 that includes a main body housing 402 and an elongate receiver housing 404. In this example, portable electronic device 400 is a portable phone (such as a cellular phone or a portable handset that is used with a base unit connected to a standard telephone line). However, it must be emphasized that many other types of portable electronic devices can be recharged using the apparatus and method of the present invention. In the case of a portable phone, the portable electronic device inherently includes elongate receiver housing 404, since the receiver housing comprises an antenna that is used to receive and transmit radio frequency signals. Many portable electronic devices include antennas (radios, portable phone handsets, cell phones, remote controlled toy vehicles, etc.). When such a portable electronic device is to be recharged in accord with the present invention, the antenna required by that portable electronic device to implement its principal function, and the receiver coil that electromagnetically couples with a varying magnetic field to generate a current, are both disposed in elongate receiver housing 404, and in some cases, may comprise the same component(s). If the portable electronic device to be recharged in accord with the present invention does not require an antenna, elongate receiver housing 404 will include the receiver coil, but will not be used to transmit and/or receive RF communication signals. Elongate receiver housing 404 can either be a separate housing that is attached to main body housing 402, or elongate receiver housing 404 and main body housing 402 can be integral parts of a common housing. Note that elongate receiver housing 404 extends outwardly and away from main body housing 402, such that very little of magnetic field directed at elongate receiver housing 404 in the present invention, passes through the main body housing 402. The elongate shape of elongate receiver housing 404 is particularly well suited for both antennae and elongate-shaped receiver coils, and helps to ensure that the receiver coil to which the magnetic field will be coupled is disposed away from main body housing 402. However, it is anticipated that other shapes can be employed for the receiver housing, so long as the receiver housing is disposed such that the magnetic field coupled to the receiver coil is substantially directed away from main body housing 402.

FIG. 1B is a plan view of portable electronic device 400 placed into a charging base unit 406 that includes a cradle portion 408 and a charging portion 410. Cradle portion 408 preferably has a size and shape adapted to support the main body housing 402. While in the example shown, cradle portion 408 is substantially the same size and shape as main body housing 402, it should be understood that cradle portion 408 can be made substantially larger than shown, such that a different portable device, having a larger main body portion, can be placed into the cradle portion. Charging portion 410 is similarly of a size and shape adapted to receive elongate receiver housing 404. It should be noted that even for portable devices having main body housings of substantially different sizes and shapes, it is contemplated that elongate receiver housing 404 be readily coupled to portable devices of disparate sizes. By proper placement of elongate receiver housing 404 relative to different size main body housings, and the use of a relatively large cradle portion, a single charging base unit can accommodate a wide variety of different sizes and types of portable devices.

Note that the position of the main body housing of the portable device relative to the cradle portion is not critical, as long as the cradle portion provides support to the main body housing of a device being recharged. It is important that elongate receiver housing 404 be properly positioned relative to charging portion 410 to ensure that the varying magnetic field produced adjacent to charging portion 410 is able to couple with the receiver coil disposed within elongate receiver housing 404. Ensuring that charging portion 410 has a size and shape generally corresponding to elongate receiver housing 404 will help to ensure that the desired coupling occurs. Particularly when the cradle portion is oversized relative to the main body housing of a portable device, it may be desirable to include optional gripping means 412 in charging portion 410. One suitable component comprising the gripping means is an elastomeric bead that is capable of releasably gripping elongate receiver housing 404 in an interference fit. Such an elastomeric bead will enable elongate receiver housing 404 to remain stationary during the charging process, even when the cradle portion is so oversized relative to a main body housing of a portable device that the cradle portion provides little or no positioning function for the main body housing. Alternatively, the material used to form the charging portion can be made of an elastomeric material, and sized such that an interference fit exists between the receiver housing and the charging portion. The receiver housing can be made of a resilient material, and the charging portion made of a non-resilient material, such that an interference fit is readily established between the receiver housing and the charging portion. A mechanical latching mechanism (not shown) could alternatively be employed for this purpose.

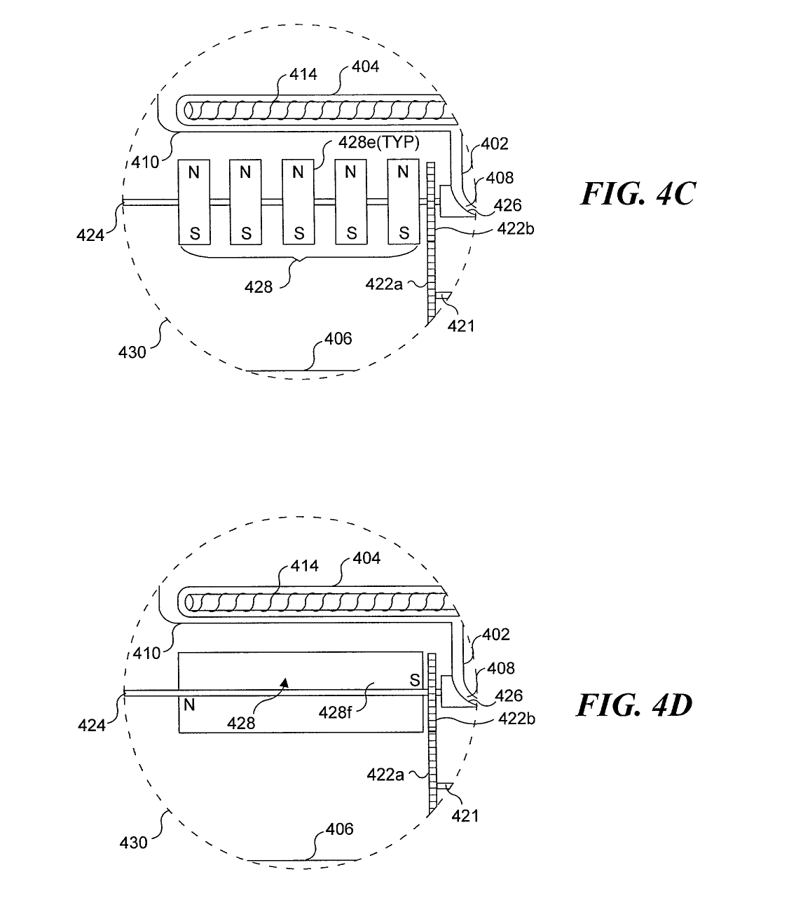

An interior view of relevant components of portable electronic device 400 and charging base unit 406 is provided in FIG. 2. A receiving coil 414 is disposed within elongate receiver housing 404. While not separately shown, it should be understood that if portable electronic device 404 includes an antenna, the antenna will also be disposed within elongate receiver housing 404, or may comprise the same elements as receiving coil 414. Note that receiving coil 414 must be capable of carrying an electrical current that is induced in the receiving coil when it is exposed to a varying magnetic field. The receiving coil is preferably fabricated from copper (or other conductive) wire 414a that is helically wrapped around a core 414b (also see FIGS. 4A and 4B). The core will preferably be fabricated of a metal or ferrous alloy having a relatively high magnetic permeability to improve the efficiency with which an electrical current flow is induced in the receiving coil. It is contemplated that the winding pattern for the receiving coil will be optimized for the length, shape, and thickness of the associated structures to best induce the required electrical current to flow in the receiving coil.

Preferably, receiving coil 414 is coupled to a circuit 416 that monitors and/or conditions (i.e., regulates and rectifies) the electrical current before supplying current to recharge a rechargeable battery 418. Suitable conditioning circuits for use in the present invention are well known in the art, and may be purchased from various vendors as a single integrated circuit, such as a model MM1433 integrated circuit designed for charging a lithium ion battery and made by the Mitsumi Corporation of Japan. It will be understood by those skilled in the art that a different conditioning circuit will be required for other types of batteries, e.g., a conditioning circuit specifically designed for use with nickel-cadmium batteries will be required when the rechargeable battery is a nickel-cadmium battery.

Charging base unit 406 includes an electric motor 420, which is mounted on a support 424. A shaft 421 of electric motor 420 rotatably drives a gear 422a, which in turn, meshes with and rotatably drives a gear 422b. Preferably, electric motor 420 is energized by an external power source, such as by being connected to a standard 110-120 volt AC line outlet (not separately shown). Gear 422b is coupled to a shaft 424, which is rotatably mounted in bearing supports 426. As shaft 424 rotates, a permanent magnet structure 428 also rotates, causing lines of magnetic flux to cross through core 414b of the receiving coil, thus inducing a current in coil 414a, which is wrapped around the core. The current can be employed to recharge battery 418, or to supply power to the components of a portable device other than a battery. Area 430 indicates the limits of the relatively strong magnetic field produced by the rotating magnetic assembly. This magnetic field encompasses substantially all of receiving coil 414, but very little of main body housing 402. While it is clearly true that the magnetic field extends beyond area 430, its strength is relatively weak and becomes increasingly weaker in regard to overlapping or intersecting the volume occupied by the main housing of the portable device.

It should be noted that charging base unit 406 represents only one exemplary design, and that other configurations of prime movers and moving elements are both possible and contemplated. For example, a magnetic field generator can be provided in which the permanent magnet element is stationary, and a prime mover causes another flux shorting element to move relative to the permanent magnet, thereby generating a varying magnetic field, as explained in greater detail below. Other types of prime movers beside an electric motor can be employed to create the varying magnetic field if desired, also as described in detail below.

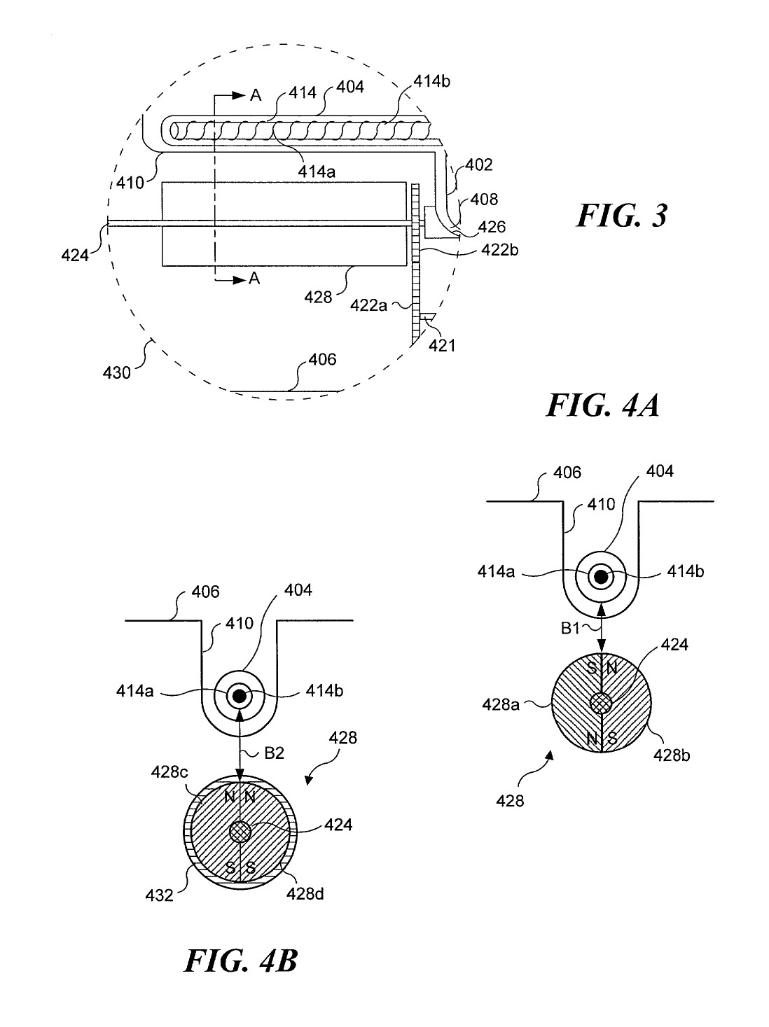

FIG. 3 shows an enlarged view of area 430, enabling receiving coil 414 to be more clearly seen. FIGS. 4A and 4B illustrate different embodiments of magnet structure 428. In FIG. 4A, magnetic structure 428 includes two permanent magnets 428a and 428b that are arcuate in shape and are joined so that the north and south poles of each magnet are adjacent to each other. In such a configuration, the magnet's own magnetic attraction provides the force that couples the magnets to shaft 424. It should be noted that in such a configuration, the resulting magnetic field will not extend much beyond permanent magnets 428a and 428b, as the magnetic field will be concentrated within the magnets themselves. Thus, a distance B1 between the receiving coil and the magnet structure must be relatively short, and/or permanent magnets 428a and 428b quite strong, for sufficient inductive coupling to occur within receiver coil 414.

A more preferred embodiment is illustrated in FIG. 4B, in which magnetic structure 428 is made up of two permanent magnets 428c and 428d. Again, permanent magnets 428c and 428d are arcuate in shape, but in this embodiment the magnets joined so that the north and south poles of each magnet are disposed adjacent to each other. In such a configuration, one or more sleeves 432 must be employed to hold the magnets together, coupling the magnets to shaft 424. In the magnetic structure configuration of FIG. 4B, the resulting magnetic field extends much further beyond permanent magnets 428c and 428d than in the embodiment illustrated in FIG. 4A. Thus, a distance B2 between the magnetic structure and the receiving coil can be larger than distance B1, and/or permanent magnets 428c and 428d can be less powerful than permanent magnets 428a and 428b, for sufficient inductive coupling to be achieved with receiver coil 414.

It should be understood other shapes of magnets, other than arcuate, can also be readily employed. For example, in FIG. 4C, magnetic structure 428 is comprised of a plurality of individual permanent magnets 428e, spaced apart along shaft 424. Permanent magnets 428e can be simple bar magnet, or disc shaped magnets. FIG. 4D illustrates an embodiment in which magnetic structure 428 includes a single elongate permanent magnet 428f, which can be a simple bar magnet or an arcuate magnet, as shown in FIGS. 4A and 4B. Regardless of the shape or number of magnets employed in magnetic structure 428, when shaft 424 is rotated, a varying magnetic field must be developed to induce a current to flow in receiver coil 414, so that a portable device can be re-energized or a battery within it recharged.

The following describes additional embodiments in which different arrangements of magnets and driven elements are employed to generate a varying magnetic field in a charging portion of a base unit housing, that is directed toward a receiver coil disposed in a receiver housing. Note the varying magnetic field so produced, preferably, does not substantially overlap with a main body housing of the portable device. It should be noted that the following embodiments focus primarily on the arrangement of parts relating to flux generators used to produce the varying magnetic field, and not all the following figures illustrate a base unit (flux generator) housing having both a cradle portion and a charging portion as described above. Similarly, not all the following figures illustrate a portable device having a receiver housing and a main body housing. However, it should be understood that the following embodiments each include the elements of a cradle portion, a charging portion, a receiver housing, and a main body housing as described above.

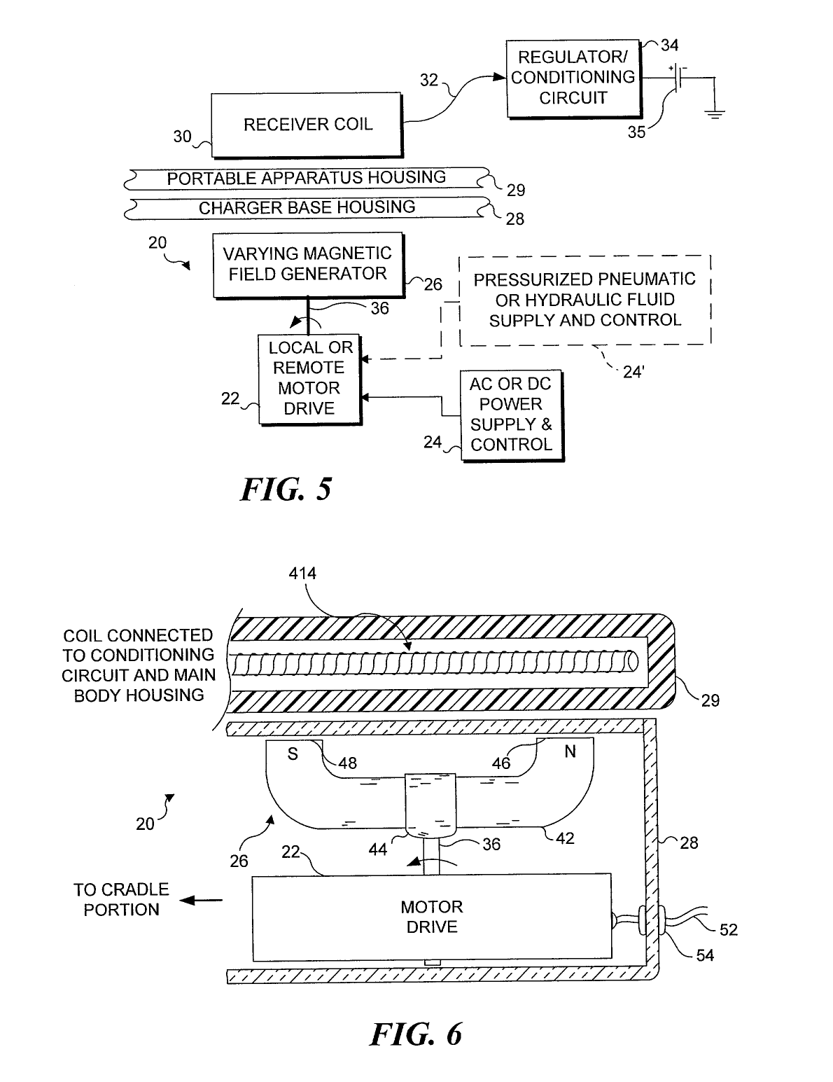

With reference to FIG. 5, a block diagram shown therein illustrates a typical application of the present invention. In this application, a flux generator base 20 includes a local (or remote) motor drive 22 that is energized from a power supply/control 24. Local (or remote) motor drive 22 comprises a prime mover that supplies a mechanical driving force to actuate a varying magnetic field generator 26. While the motor drive is preferably electrical, it is also contemplated that a pneumatic or hydraulic motor can alternatively be used as the prime mover. A pressurized pneumatic or hydraulic fluid supply and control 24′ is shown for use in controlling such a motor. By using a fluid drive motor, electrical current to and in the device is eliminated, which may be desirable in certain applications. However, an electrically powered motor is typically lower in cost and generally preferable. To provide electrical current to operate an electrical motor, power supply/control 24 is preferably energized by connection to an AC line source (not separately shown). However, a DC battery supply might be used in certain applications, for example, when power is provided by connection to an automotive electrical system. It is also contemplated that a hand crank (not shown) can be employed for actuating magnetic field generator 26 to produce a varying magnetic flux.

If the mechanical driving force for actuating a varying magnetic field generator 26 is provided locally, the motor drive is coupled to the varying magnetic field generator through a drive shaft 36. Conversely, if the motor drive is disposed at a remote point, separate from the varying magnetic field generator, the mechanical driving force can be provided through a flexible cable (not separately shown) that extends between the remote motor drive and varying magnetic field generator 26. The movement produced by the motor drive causes a variation in the magnetic field produced by magnetic field generator that changes the magnetic flux through a path outside of flux generator base 20.

Flux generator base 20 is intended to produce a varying magnetic field that induces a corresponding electrical current to flow in a conductor in the receiver coil. The conductor is disposed sufficiently close to the flux generator base to enable magnetic coupling between the conductor and the flux generator to occur. In one preferred application of the flux generator base, the varying magnetic field it produces passes through a charge base housing 28 in which the varying magnetic field generator is disposed and a separate portable apparatus housing 29 in which a receiver coil 30 is disposed. The receiver coil is preferably coupled to a battery disposed in a main body portion of housing 29, while the receiver coil is disposed in a receiver housing portion of housing 29. Note that it is the receiver housing portion of housing 29 that is positioned directly opposite varying magnetic field generator 26. Preferably, housings 28 and 29 comprise material through which magnetic flux readily passes, such as plastic, fiberglass, or a composite. A typical separation between varying magnetic field generator 26 and receiver coil 30 is from about 0.5 cm to about 2.0 cm.

Receiver coil 30 is connected to a conditioning circuit 34 through a lead 32, which conveys the electrical current induced in the receiver coil by the varying magnetic field; this electrical current is then appropriately regulated by the conditioning circuit to achieve a voltage and current appropriate to recharge the battery (or batteries) connected thereto.

The conditioning circuit may be used to energize a storage battery or storage capacitor for storing energy coupled to receiver coil 30. Alternatively, a battery or capacitor for storing energy (neither shown) may be disposed at the receiver coil. It will also be apparent that the portable device can be directly energized using the present invention, in which case, an energy storage device need not be provided.

Preferably, receiver coil 30 is substantially similar to receiver coil 414 described above. However, it is anticipated that in some applications, a different type of receiver coil, such as an air core receiver coil, or a receiver coil having a shape different than receiver coil 414, may be beneficially employed.

As discussed above, charger base housing 28 preferably includes both a charging portion and a cradle portion, such that the varying magnetic field is substantially directed toward the charging portion, but not toward the cradle portion. As shown in FIG. 1B, the charging portion preferably includes an elongate depression having a size and shape adapted to receive an antenna shaped (elongate) receiver coil. While such a feature is not specifically shown in housing 28, it should be understood that such a feature is preferably incorporated in the charging portion of housing 28. Similarly, as discussed above, separate housing 29 includes both a receiver housing, toward which the varying magnetic field is directed, and a main body portion which receives little if any magnetic flux.

FIG. 6 illustrates a first embodiment of flux generator base 20 in which motor drive 22 is disposed within housing 28 of the flux generator base. Motor drive 22 is coupled to a generally elongated U-shaped permanent magnet 42 through rotating drive shaft 36. The rotating drive shaft connects to a collar 44 around the midsection of permanent magnet 42. Preferably in this and in each of the other embodiments of the present invention described below (and above), the permanent magnet is formed of a neodymium-iron-boron alloy or other rare earth or metal alloy that produces a relatively high magnetic flux density. Other types of ferro-magnetic alloys are also acceptable for this purpose, although it is generally desirable to use a material for the permanent magnets that produces a relatively strong magnetic field in the present invention. Permanent magnet 42 includes a north pole face 46 and a south pole face 48 that face upwardly and are disposed immediately adjacent the interior side of the lower surface of housing 28. To prevent undesired shunting of the magnetic flux between north pole face 46 and south pole face 48 and eddy current losses that would occur if a magnetic flux conductive material were used, housing 28 preferably comprises a plastic polymer material that is a good electrical insulator and does not block the magnetic flux produced by the permanent magnet. In instances where the motor drive comprises an electric motor, an electrical current appropriate to energize the motor drive is supplied by electrical leads 52, which run through a grommet 54 disposed in the side of housing 28.

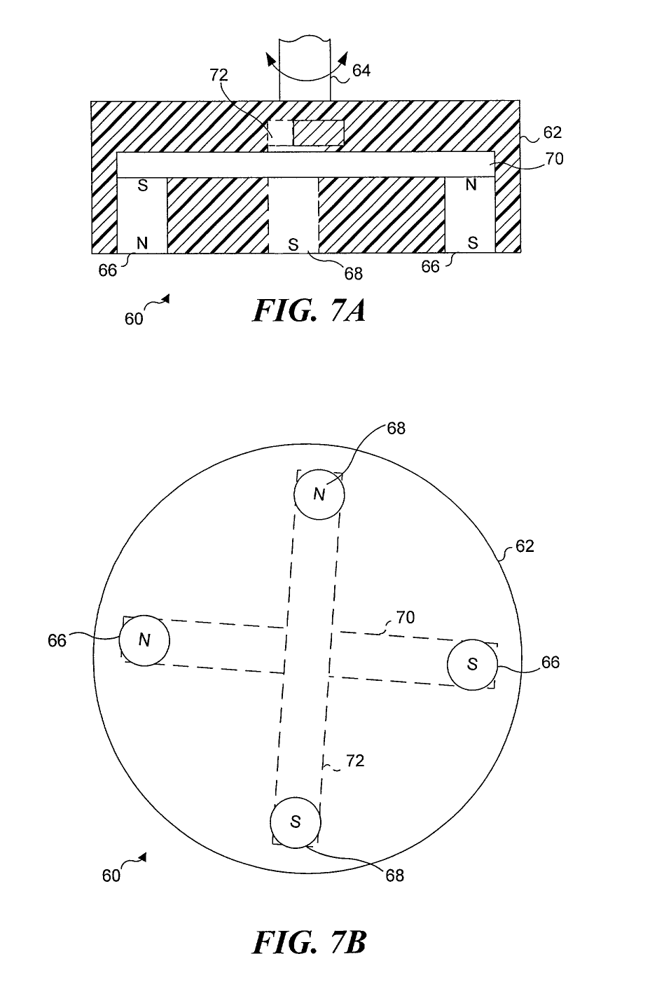

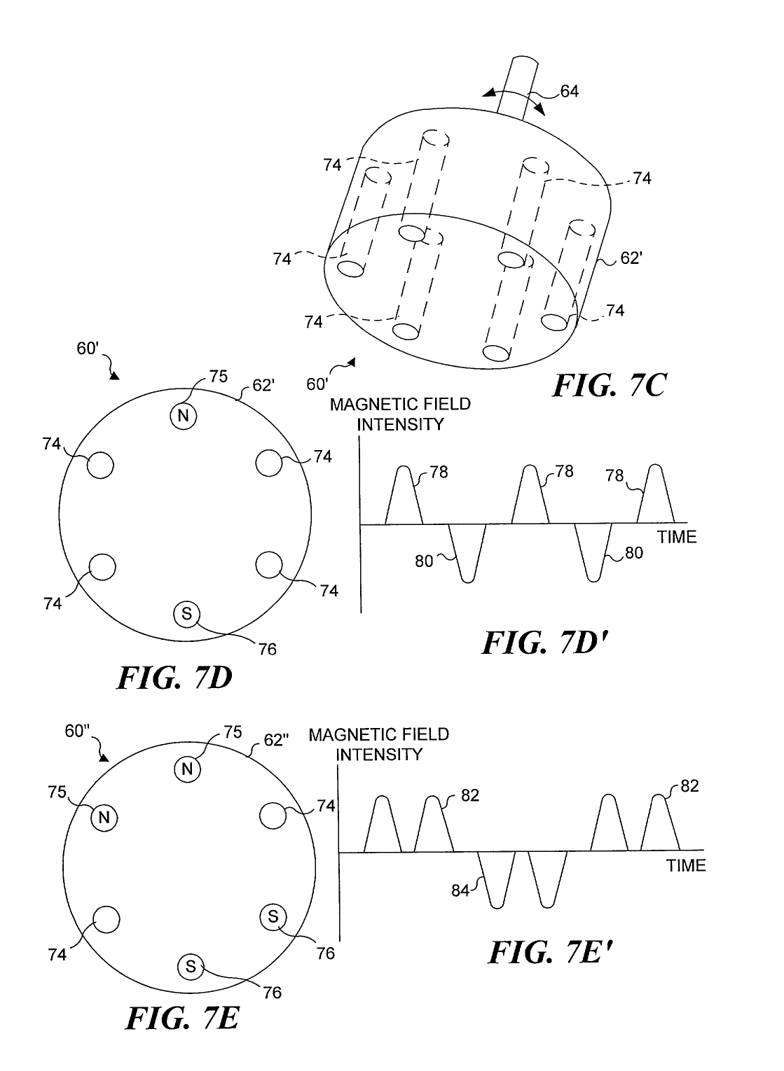

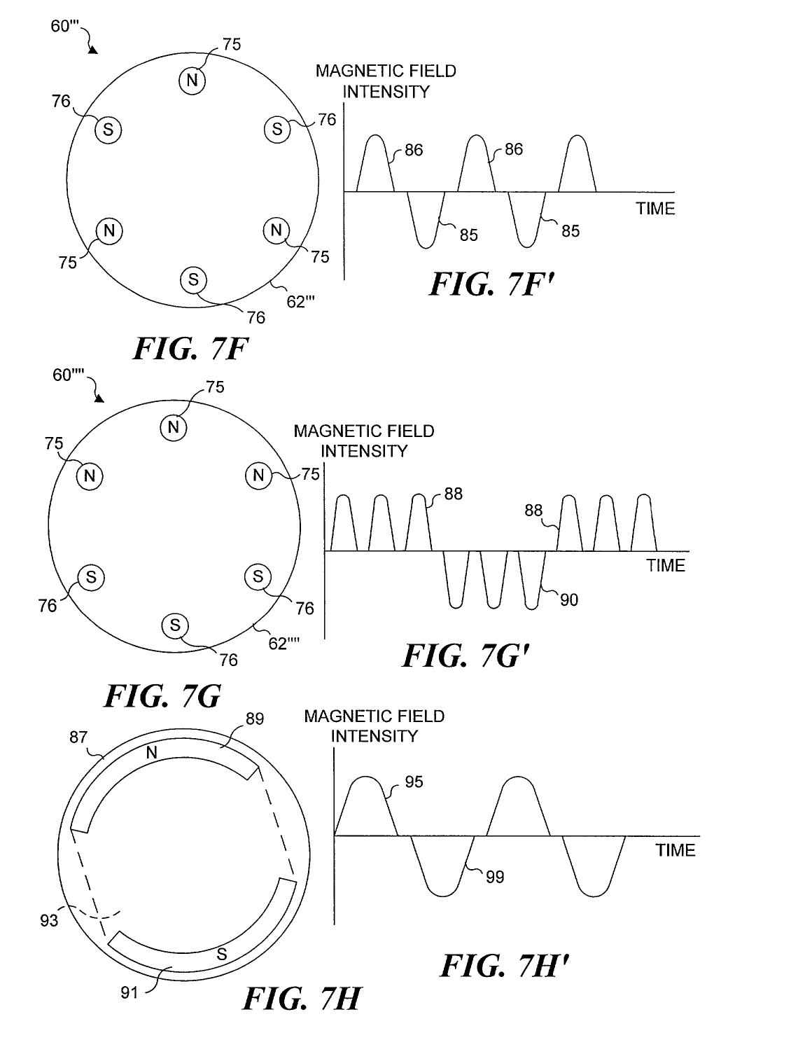

FIGS. 7A and 7B show an alternative embodiment illustrating a varying magnetic field generator 60. In these figures, the housing and motor drive of the charger are not illustrated, but it will be apparent that a housing such as housing 28 can enclose a varying magnetic field generator 60. A local or a remote motor drive is coupled to a drive shaft 64 to rotate a disk 62, which comprises the varying magnetic field generator, in either direction about a longitudinal axis of drive shaft 64. Embedded within disk 62 are two sets of permanent magnets 66 and 68; the north pole face of one of these permanent magnets and the south pole face of the other permanent magnet is generally flush with the lower surface of disk 62 (as shown in the figure). A flux linkage bar 70 extends between the south and north pole faces of permanent magnets 66 (within disk 62), while a flux linkage bar 72 extends between the north and the south pole faces of permanent magnets 68 (within disk 62). The relationship of the permanent magnets and flux linkage bars are best illustrated in FIG. 7B.

Rotation of disk 62 about its central axis in either direction varies the magnetic field experienced at receiver coil 30 (shown in FIG. 5) and alternately changes the polarity of the field as the different permanent magnets rotate to positions adjacent to the pole faces of the receiver coil. The varying magnetic field that is thus produced by rotation of disk 62 induces a generally corresponding varying electrical current in the receiver coil that is usable to energize a device such as a portable hand tool, or to charge a battery in a portable device. Preferably, the electrical current supplied to the device is first conditioned by conditioning circuit 34 (also shown in FIG. 5), for example, to rectify, filter, and regulate the current. The speed at which disk 62 rotates changes the frequency of the induced electrical current and also varies the average magnitude of the electrical current induced in the receiver coil. It is contemplated that disk 62 can be rotated at a rate such that the frequency of the current induced in the receiver coil is within the range from less than 10 Hz to more than 10 kHz.

It should be noted that the power transferred to the receiver coil increases as the rotational speed of the varying magnetic field generator increases. Also, as the relative spacing between varying magnetic field generator 60 and the receiver coil changes, the amplitude of the induced electrical current also changes, i.e., the magnitude of the induced electrical current increases as the separation decreases. While not shown in any of the figures, it will be apparent that the elevation of rotating disk 62 above the receiver coil can be readily changed to modify the respective separation between the two devices and thereby selectively determine the maximum current induced in the receiver coil—all other parameters such as rotational speed remaining constant.

FIGS. 7D-7G show further embodiments of the varying magnetic field generator of the type illustrated in FIGS. 7A and 7B. The disk configuration for the varying magnetic field generator illustrated in these figures was first used to confirm the effectiveness of the present invention. In FIG. 7C, a disk 62′ is shown without any permanent magnets. In an embodiment 60′ shown in FIG. 7D, only two permanent magnets 75 and 76 are inserted within disk 62′, and other cavities 74 in disk 62′ do not contain permanent magnets. As shown in the figure, permanent magnet 75 is positioned within disk 62′ with its north pole face facing downwardly, flush with the lower surface of the disk, while permanent magnet 76 is positioned with its south face facing downwardly, flush with the lower surface of the disk. The opposite pole faces of each of permanent magnets 75 and 76 are directed upwardly, and the longitudinal axes of the permanent magnets are generally aligned parallel with the axis of drive shaft 64.

To test the efficacy of the embodiments shown in FIGS. 7D-7G, drive shaft 64 was simply chucked in a drill press (not shown) and rotated so that the lower surface of the disk in which the permanent magnets are embedded passed immediately above a receiver coil (similar to receiver coil 414). Using only one permanent magnet 75 and one permanent magnet 76 as shown in FIG. 7D, the magnetic field intensity waveforms illustrated in the graph of FIG. 7D′ were produced, and these waveforms include positive pulses 78 and negative pulses 80.

When two permanent magnets 75 and two permanent magnets 76 were disposed opposite each other as shown in FIG. 7E, rotation of a disk 62″ induced magnetic field intensity waveforms comprising two positive pulses 82 followed by two negative pulses 84 in repetitive sequence, as shown in FIG. 7E′. Alternating permanent magnets 75 and 76 in each of the cavities formed in a disk 62′″ to produce a varying magnetic flux generator 60′″ as shown in FIG. 7F, produced higher frequency magnetic field intensity waveforms, including positive pulses 86 and negative pulses 85, which are more sinusoidal, as indicated in FIG. 7F′. In the embodiment of varying magnetic field generator 60″″, shown in FIG. 7G, three permanent magnets 75 are disposed adjacent each other with their north pole faces flush with the lower surface of a disk 62″″, while three permanent magnets 76 have the south pole face flush with the lower surface of the disk. Rotation of disk 62″″ produced the magnetic field intensity waveforms shown in FIG. 7G′, which include three positive pulses 88 followed by three negative pulses 90, in repetitive fashion.

In FIG. 7H, a disk 87 includes two generally arcuate-shaped permanent magnets 89 and 91 disposed adjacent radially opposite sides of the disk, with the north pole of permanent magnet 89 and the south pole of permanent magnet 91 flush with the lower surface of the disk (as shown in the figure). A flux linkage bar 93 extends across the disk, over the opposite poles of the two permanent magnets. Due to the arcuate shape of the permanent magnets, they extend over a larger portion of the rotational arc of disk 87, causing generally sinusoidal magnetic field intensity waveforms 95 and 99 to be magnetically induced in the receiver coil, as shown in FIG. 7H′.

At relatively slow rotational speeds, the rotation of one or more very strong permanent magnets directly below a receiver coil may apply sufficient torque to the receiver coil to cause the receiver coil to move back and forth slightly. However, any movement or vibration of the receiver coil due to such torque will be substantially eliminated when the receiver coil is attached to the device that is to be energized or which includes a battery to be charged by the present invention. Furthermore, if the rotational speed of the varying magnetic field generator is sufficiently high, the effects of any torque applied to the receiver coil will be almost imperceptible.

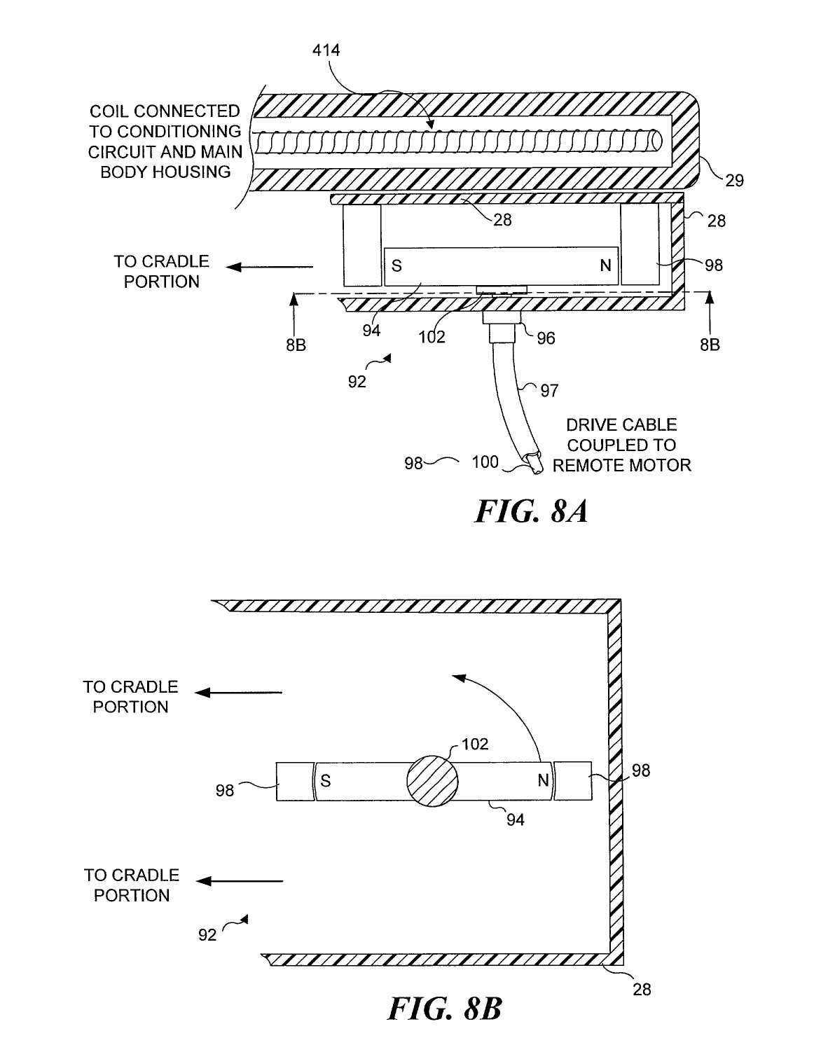

In FIGS. 8A and 8B, a flux generator base 92 is illustrated that eliminates virtually all torque on the receiver coil. In this embodiment, a permanent magnet 94 is coupled through a connection 102 to a flexible cable 100, which turns within a flexible drive shaft 97. Flexible cable 100 is connected to a remote electrical drive motor (not shown in this figure) that applies a rotational driving force to the flexible drive shaft. The flexible drive shaft rotates within a bearing 96 that is supported in housing 28 of flux generator base 92. As noted above, housing 28 is preferably fabricated of a plastic polymer that does not block or shunt magnetic flux and which does not conduct eddy currents. Further, housing 28 represents a charging portion which is attached to a cradle portion of the housing comprising the charging base (see FIGS. 1B and 2). Inside housing 28, at diametrically opposite sides of the housing, are disposed two vertically-aligned flux linkage blocks 98. As permanent magnet 94 rotates, its north and south poles pass adjacent to the top inwardly facing surfaces of flux linkage blocks 98, as shown in FIG. 8B. The magnetic flux produced by permanent magnet 94 is conveyed through the flux linkage blocks and coupled into overlying receiver coil 414. Flux generator base 92 is disposed relative to receiver coil 414 such that the upper ends of the flux linkage blocks are disposed adjacent to separate location on receiver coil 414. Since permanent magnet 94 rotates in a plane that is substantially spaced apart from the top of housing 28 (as illustrated in the figure), the permanent magnet supplies substantially less attractive force to the overlying receiver coil than would be the case if the permanent magnet were rotating in a plane closer to the receiver, e.g., immediately adjacent to the top of housing 28. Furthermore, flux linkage blocks 98 tend to concentrate the magnetic flux produced by the rotating permanent magnet in a vertical direction, minimizing any horizontal component of the magnetic flux, so that little rotational force is experienced by receiver coil 414.

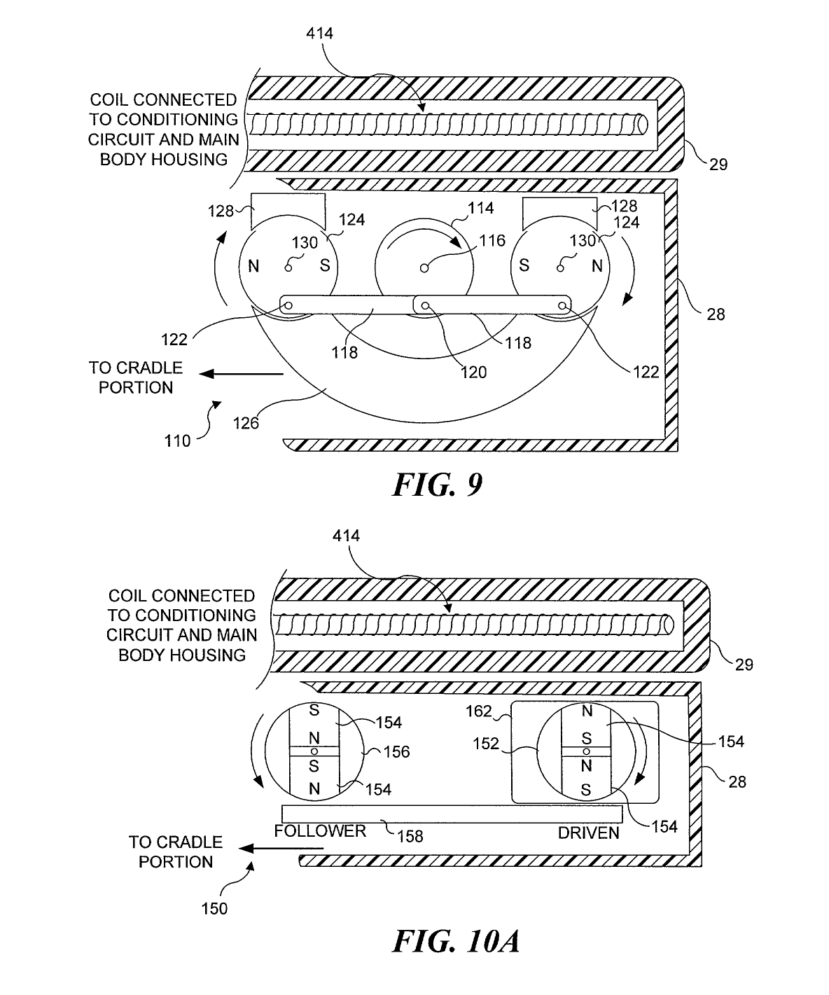

Referring now to FIG. 9, another embodiment comprising a flux generator base 110 is disclosed. In flux generator base 110, two cylindrical permanent magnets 124 are provided, each of which rotate around shafts 130 that extend through their respective centers. Alternatively, more conventional bar-shaped permanent magnets mounted in a plastic polymer cylinder can be used. Mechanical link bars 118 are attached to each of the permanent magnets at pivot points 122 and extend to a common pivot point 120 on a rotating driven wheel 114 that is disposed midway between the two permanent magnets. Driven wheel 114 is rotated by a drive shaft 116 that is connected to an electrical drive motor (not shown) disposed either within flux generator base 110, or alternatively, at a more remote location, as discussed above. Since pivot point 120 is offset from drive shaft 116; i.e., offset from the center of the driven wheel 114, movement of pivot point 120 due to rotation of the driven wheel is translated by mechanical link bars 118 into a corresponding rotational force applied to pivot points 122 that causes permanent magnets 124 to rotate about their shafts 130. As corresponding north and south poles on permanent magnets 124 move to positions immediately adjacent a curved flux linkage bar 126, the opposite poles of the permanent magnets are disposed adjacent vertically aligned flux linkage bars 128. In this figure, the lower ends of the flux linkage bars are disposed adjacent the top of flux generator base 110, spaced apart and directly opposite portions of receiver coil 414. As noted above, receiver coil 414 is preferably fabricated with a core of a metal or ferrous alloy having a relatively high magnetic permeability, about which is coiled a plurality of turns of an electrical conductor, the ends of which comprise a lead that extends to the conditioning circuit (neither shown in this figure) that rectifies, filters, and regulates the current from receiver coil 414, as required by the device to which the receiver coil is connected. The varying magnetic flux applied to receiver coil 414 induces a corresponding varying electrical current to flow through the turns of conductive wire comprising receiver coil 414.

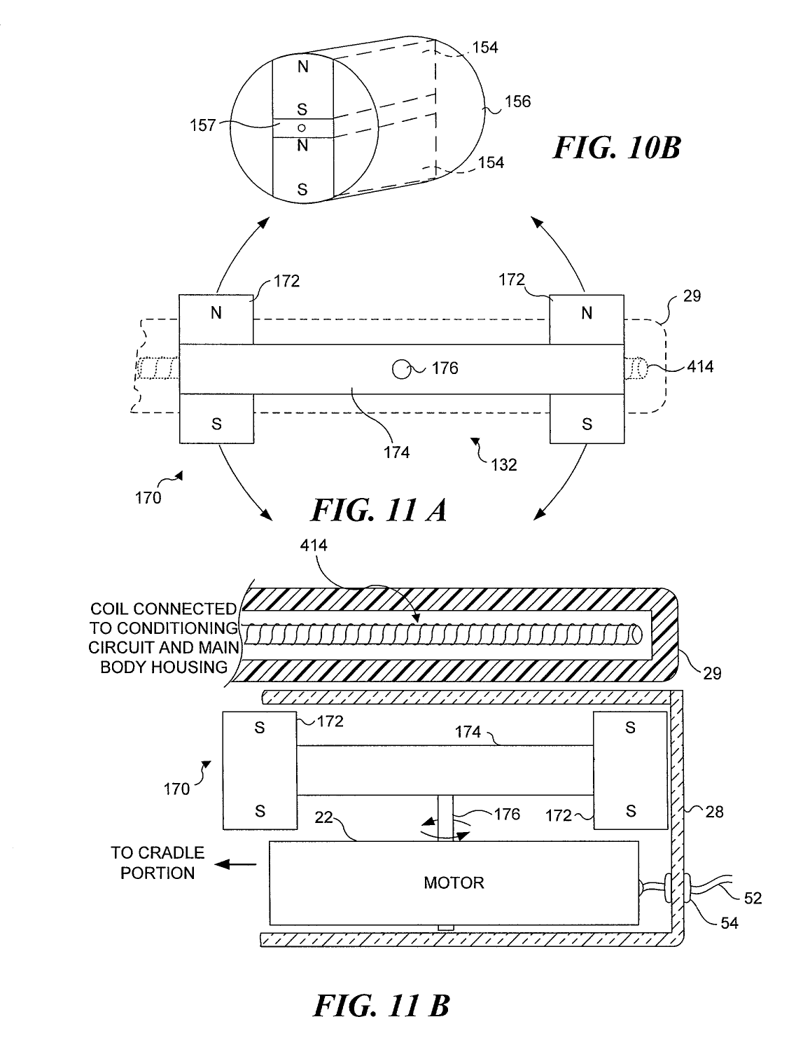

Another embodiment of a flux generator base 150 is illustrated in FIG. 10A. In this embodiment, a driven wheel 152, fabricated of a plastic polymer or other suitable non-magnetic material bonded to a pair of permanent magnets 154, is rotated by a motor drive 162. Magnetic flux from permanent magnets 154 is coupled through a horizontally extending flux linkage bar 158 disposed below the driven wheel (as shown in the figure) to a follower wheel 156, which also includes a pair of permanent magnets 154 bonded together with their respective north and south pole faces facing each other, separated by a flux linking section 157, best seen in FIG. 10B. (The structure of driven wheel 152 is substantially identical to that of follower wheel 156.) Rotation of driven wheel 152 causes a varying magnetic field polarity to be experienced by permanent magnets 154 on follower wheel 156 and the interaction with this magnetic field rotates the follower wheel generally in lock step with the rotation of driven wheel 152. As a consequence, magnetic flux from the pairs of permanent magnets 154 on the driven wheel and follower wheel couple into receiver coil 414, inducing an electrical current to flow in the turns of a wire wrapped about a core in the receiver coil, for use in energizing a portable device or charging its batteries.

The embodiments of flux generator bases discussed thus far have all included permanent magnets that rotate. In FIG. 11, a flux generator base 170 is illustrated that includes a flux linkage bar 174 mounted to a shaft 176. Shaft 176 reciprocatively rotates back and forth, causing permanent magnets 172 to pass back and forth adjacent portions of receiver coil 414. As the magnetic flux produced by the permanent magnets and experienced by receiver coil 414 periodically change due to the reciprocating movement of the permanent magnets back and forth on adjacent portions of the receiver coil, an electrical current is induced to flow within the turns of the conductor wrapped around the core of receiver coil 414. This electrical current is typically rectified, filtered, and regulated to meet the requirements of the device coupled to the receiver coil. Note that for the sake of simplicity, a housing has not been shown relative to flux generator base 170 in FIG. 11A, although the unit preferably includes a housing having charging portion (with an elongate depression adapted to receive a receiver housing) and a cradle portion, as described above. For at least one embodiment, FIG. 11A represent a bottom plan view, and electric motor 22 (see FIG. 11B) or another primer mover is positioned such that linkage bar 174 is disposed between motor 22 and receiver coil 414.

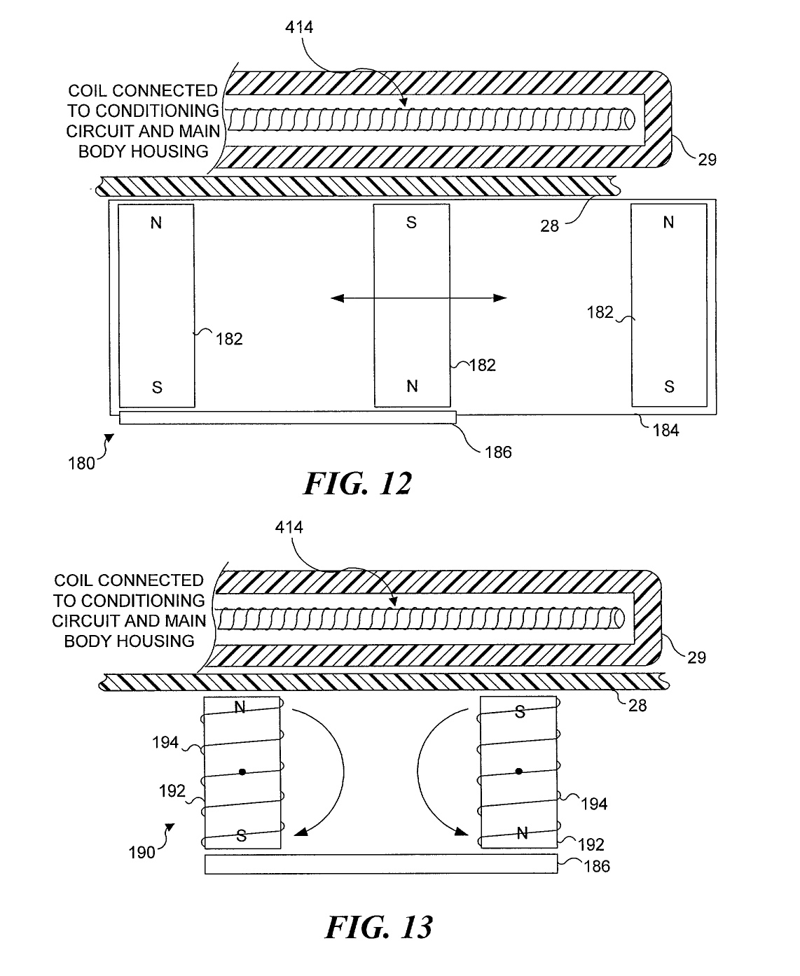

Instead of being rotatably reciprocated back and forth, the permanent magnets can be driven to move back and forth in a linear fashion, as in the embodiment of a flux generator base 180 illustrated in FIG. 12. In this embodiment, a flux shunt bar 186 is disposed below three vertically-aligned and spaced-apart permanent magnets 182 and extends over the respective north and south poles of two of the permanent magnets. The downwardly facing poles of permanent magnets 182 are respectively south, north, and south (or each can be of opposite polarity), in the order in which they are attached to a moving plate 184 that is reciprocatively driven back and forth. The spacing between permanent magnets 182 is such that at the two extreme linear positions of reciprocating plate 184, the poles of two of the permanent magnets are disposed immediately below portions of receiver coil 414; these poles are opposite in polarity. Linear reciprocating movement of reciprocating plate 184 is provided by an appropriate drive mechanism (not shown), receiving its motive power from an electrical motor drive (also not shown), which is disposed either locally with the flux generator base, or remotely and coupled to the flux generator base by a drive shaft.

In FIG. 13, an embodiment of a flux generator base 190 is illustrated that has provision for selectively electrically controlling the strength of the magnetic field coupled to receiver coil 414. In this embodiment, instead of varying the separation between rotating permanent magnets 192 and receiver coil 414, an electrical conductor 194 is coiled around each of permanent magnets 192 and is coupled to a variable current power supply (not shown) that provides a DC current flowing through conductor 194. Note that permanent magnets 192 can be rotated about a common axis that is orthogonal to the axes of the rotation shown in the figure. Since permanent magnets 192 are rotating, being driven by an electrical motor drive (also not shown in FIG. 13), conductor 194 must be coupled to the variable power supply using slip rings, brushes, a rotary transformer, or other suitable mechanism, as is commonly used for coupling power to a conductor on a rotating armature of an electric motor. The DC current passing through conductor 194 can either assist or oppose the magnetic field produced by permanent magnets 192, thereby selectively varying the strength of the magnetic field experienced by receiver coil 414 to control the magnitude of the electrical current that the receiver coil supplies to the conditioning circuit.

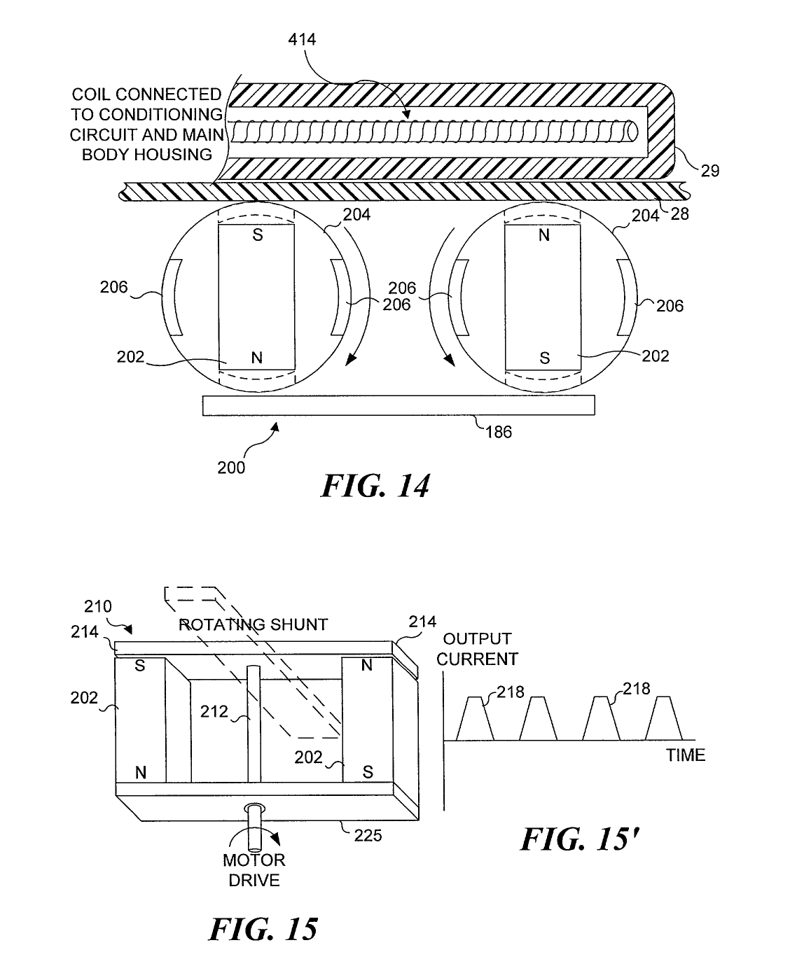

Another way to periodically vary the magnetic field experienced by receiver coil 414 is to periodically change the efficiency with which the magnetic flux produced by permanent magnets couples to the receiver coil. FIG. 14 illustrates one technique for varying the magnetic flux linkage between two permanent magnets 202 in a flux generator base 200 and the receiver coil. Permanent magnets 202 are stationary. A motor drive (not shown in this figure) drivingly rotates two disks 204 that are disposed behind each of the fixed permanent magnets. Tabs 206 extend outwardly from the facing surfaces of disks 204 a distance equal to a little more than the thickness of permanent magnets 202 (measured in a direction normal to the plane of the paper in the figure). Tabs 206 and disks 204 are fabricated of a metal or an alloy having a high magnetic permeability that provides enhanced flux linkage when disposed adjacent the poles of permanent magnets 202. A flux shunt bar 186 that is also fabricated of a material having a high magnetic permeability extends below permanent magnets 202 (as shown in this figure), but is spaced sufficiently apart from the downwardly facing poles of the permanent magnets to provide clearance for tabs 206 to pass between the flux shunt bar and the poles of permanent magnets 202. As tabs 206 rotate between the lower poles of permanent magnets 202 and the upper surface of flux shunt bar 186, and between the upper poles of the permanent magnets and portions of receiver coil 414 (as shown by the dash lines that illustrate the tabs at those positions in phantom view), the flux linkage between permanent magnets 202 and the core of receiver coil 414 greatly decreases so that substantially less magnetic field strength is experienced by the receiver coil. The magnetic flux produced by the permanent magnets is shunted through disks 204, with little of the magnetic flux flowing between the poles of the permanent magnets passing through the receiver coil. However, as disks 204 continue to rotate so that tabs 206 move to the positions shown by the solid lines in FIG. 14, the flux linkage between permanent magnets 202 and receiver coil 414 approaches a maximum. Thus, rotation of disks 204 causes the core of receiver coil 414 to experience a varying magnetic field that induces an electrical current to flow within the conductor coiled about receiver coil 414.

As shown in FIG. 15, a further embodiment of the varying magnetic field generator includes a fixed flux linkage bar 225 and a rotating flux linkage shunt 214 connected to a drive shaft 212 that rotates the flux linkage shunt in a plane above the pole faces of permanent magnets 202, so that it passes between the pole faces of the permanent magnets and the pole faces of the receiver coil (not shown here). Fixed flux linkage bar 225 and rotating flux linkage shunt 214 are both fabricated of a metal or alloy with high magnetic permeability and thus characterized by its ability to substantially shunt magnetic flux. When rotating flux linkage shunt 214 is in the position represented by the phantom view (dash lines), i.e., in a position so that its longitudinal axis is oriented about 90 degrees to the longitudinal axis of fixed flux linkage bar 225, the flux linkage between the permanent magnets and the receiver coil is at a maximum, and when the rotating flux linkage shunt is in the position shown (by the solid lines) in FIG. 15, the magnetic flux produced by the permanent magnets is substantially shunted between them through the rotating flux linkage shunt. Due to the resulting periodically varying magnetic flux coupled into the receiver coil core, an electrical current is induced in the receiver coil. FIG. 15′ illustrates electrical current pulses 218 that are produced in the receiver coil as the flux linkage shunt rotates.

A desirable feature of the embodiments shown in both FIGS. 14 and 15 is that when the devices are de-energized, leaving the magnet flux shunted between the poles of the permanent magnets, very little magnetic field produced by the permanent magnets escapes outside the housing (not shown) around the flux generator base. The rotating flux linkage shunts thus serve to “turn off” much of the external magnetic field by shunting it between the poles of the permanent magnets.

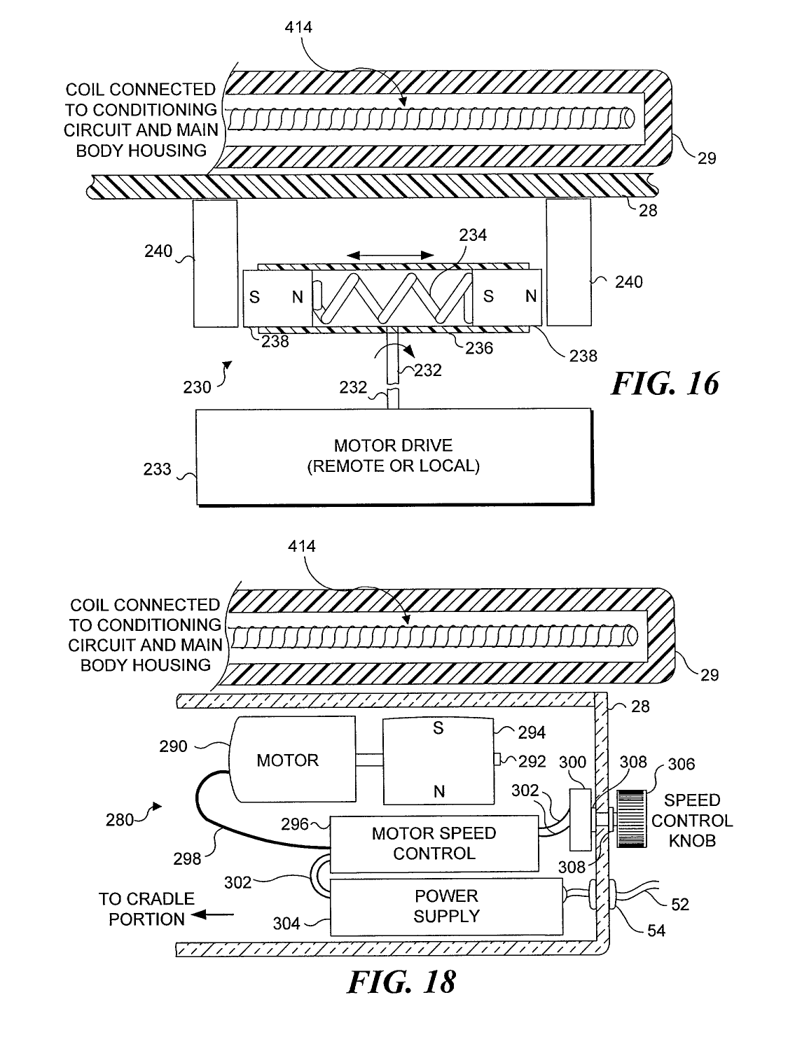

When the electric motor used as the prime mover for any of the flux generator bases described above is initially energized to provide the rotational, pivotal, or linear reciprocating motion, the motor experiences a starting torque (that resists its rotation) because of the magnetic attraction between the permanent magnets and any flux linkage bar included in the flux generator base, and the receiver coil. FIG. 16 illustrates an embodiment for a flux generator base 230 that minimizes the starting torque experienced by the electrical motor. In this embodiment, a drive shaft 232 is coupled to a local or remotely disposed electrical motor drive 233. The lower end of drive shaft 232 is connected to a horizontally extending cylindrical tube 236. Permanent magnets 238 are supported within cylindrical tube 236 and are able to move radially inward or outward relative to the longitudinal axis of drive shaft 232. The permanent magnets are coupled to a helically-coiled spring 234 that extends between the permanent magnets, within the center of cylindrical tube 236, and applies a force that tends to draw the permanent magnets radially inward, away from the lower ends of flux linkage rods 240. When the motor drive that is coupled to drive shaft 232 is de-energized, permanent magnets 238 are thus drawn toward each other, minimizing the torque required to begin rotating cylindrical tube 236. However, after motor drive 233 is rotating drive shaft 232, the centrifugal force created by the rotation of the cylindrical tube overcomes the force of helical spring 234, causing permanent magnets 238 to slide radially outward, away from the central axis of drive shaft 232, until the permanent magnets' reach stops (not shown) that limit their radial travel, so that their poles are closely spaced apart from flux linkage rods 240. A varying magnetic flux linkage with receiver coil 414 is then achieved as the permanent magnets rotate.

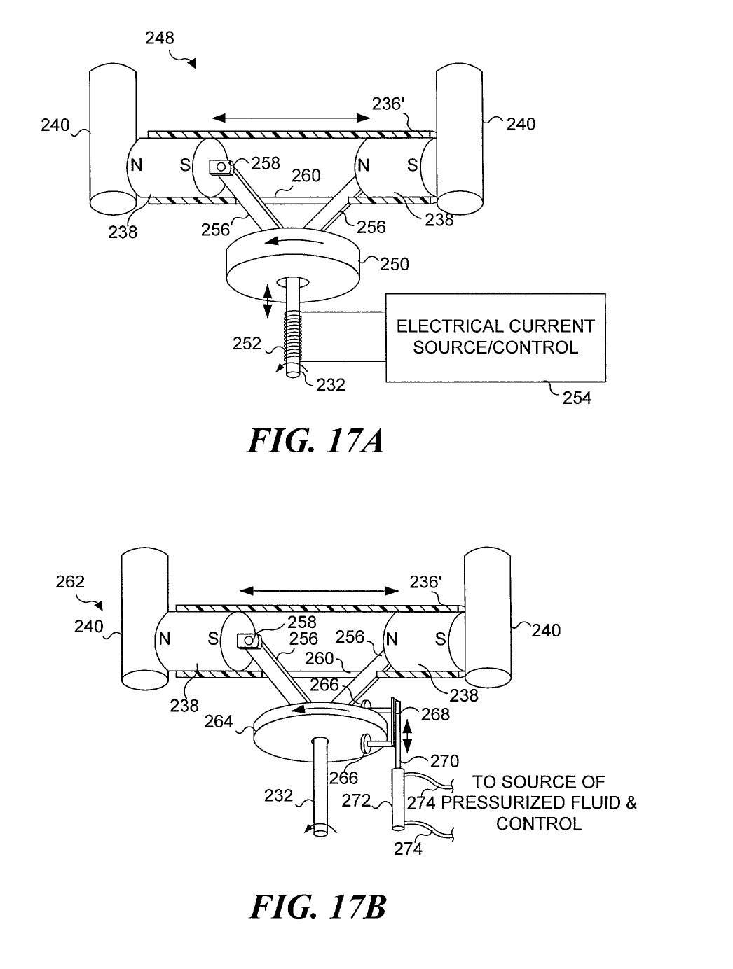

In FIGS. 17A and 17B, two alternative techniques are shown for minimizing startup torque. However, a further advantage is provided by these alternatives, since they enable the magnitude of the current produced by the receiver coil to be controlled by varying the spacing between permanent magnets 238 and flux linkage rods 240 when the permanent magnets are rotating past the flux linkage rods. Specifically, as the spacing between the permanent magnets and flux linkage rods is increased, both the coupling of magnetic flux into the receiver coil and the magnitude of the electrical current induced in the receiver coil are reduced.

FIG. 17A shows a flux generator base 248 in which drive shaft 232 rotates a ring permanent magnet 250 with a cylindrical tube 236′ and permanent magnets 238, about the longitudinal axis of the drive shaft. A solenoid coil 252 is wound around drive shaft 232 and is coupled to an electrical current source/control 254. Electrical current provided by the electrical current source/control is varied to provide a controlled magnetic force that causes ring permanent magnet 250 to move downwardly along drive shaft 232 by a controlled amount. Mechanical links 256 are pivotally connected to the ring permanent magnet and extend through a slot 260 in the cylindrical tube to couple with pivot connections 258 on the facing poles of permanent magnets 238. As the ring permanent magnet is drawn down drive shaft 232, permanent magnets 238 are drawn radially inward toward each other, reducing the magnetic flux coupled into the receiver coil (not shown in this drawing) through flux linkage rods 240. Also, when the drive shaft is initially rotated, the permanent magnets are drawn relatively closer still to each other, thereby minimizing the startup torque by reducing the attraction between the permanent magnets and the flux linkage rods.

In FIG. 17B, an alternative flux generator base 262 is shown that achieves much the same result as flux generator base 248. However, in this embodiment, a swash plate 264 is connected to pivotal connectors 258 through mechanical links 256. Swash plate 264, cylindrical tube 236′, and permanent magnets 238 are rotated by drive shaft 232. In this embodiment, bearing rollers 266 act on opposing surfaces of swash plate 264 to control its position along drive shaft 232 as the drive shaft rotates. The bearing rollers are mounted on a bracket 268 that is connected to a piston rod 270.

The position of the piston rod and thus, the position of the bearing rollers and swash plate, is adjusted by a pressurized fluid cylinder 272 that is actuated by applying pressurized hydraulic or pneumatic fluid through lines 274. The pressurized fluid is applied to drive the piston rod up or down and thereby move swash plate 264 up or down along drive shaft 232. As the swash plate moves down along drive shaft 232, it pulls permanent magnets 238 radially inward toward each other. In the fully retracted positions, permanent magnets are only weakly linked through flux linkage rods 240, and the startup torque necessary to begin rotating drive shaft 232 is minimal. As the swash plate is moved upwardly along drive shaft 232, the permanent magnets are forced outwardly, increasing the magnetic flux coupling between the rotating permanent magnets and the receiver coil. Accordingly, the magnitude of the electrical current induced in the receiver coil will be increased. It will be apparent that using either of the embodiments of the flux generator base shown in FIG. 17A or 17B, will enable the magnitude of the electrical current induced in the receiver coil to be readily controlled.

While not shown with respect to FIG. 17A or 17B, it should be understood that each flux generator preferably includes a housing having a cradle portion and a charging portion, such that the varying magnetic flux produced is substantially directed through the charging portion of the housing, and not through the cradle portion of the housing. Note that as shown in FIG. 1B, the charging portion preferably includes an elongate depression having a size and shape adapted to receive an antenna shaped (elongate) receiver coil.

FIG. 18 illustrates a flux generator base 280 that includes a motor 290 that turns a drive shaft 292 at a relatively high speed, e.g., at more than 20,000 rpm. Mounted on drive shaft 292 is a permanent magnet 294. Note that permanent magnet 294 can comprise a variety of shapes, including an elongate shape that couples to a larger portion of receiver coil 414. Motor 290 is energized with an electrical current controlled by a motor speed control circuit 296 that is also disposed in housing 28. The motor speed control circuit is generally conventional in design, including, for example, one or more silicon rectifiers or a triac, and is coupled to the motor through a lead 298. The motor speed control circuit is energized with electrical current supplied from leads 301 coupled to a line current energized power supply 304. A speed control knob 306 extends through housing 28 and is rotatable by the user to turn the device on or off and to vary the speed at which motor 290 rotates. Speed control knob 306 actuates a variable resistor 300, which is mounted just inside the housing, using a pair of threaded nuts 308. The variable resistor is connected to the motor speed control circuit through leads 302.

As illustrated in the figure, flux generator base 280 is intended to be disposed so that permanent magnet 294 is generally adjacent to at least a portion of receiver coil 414. As described above, leads from the receiver coil supply electrical current to an appropriate conditioning circuit (not shown). An electrical current is induced to flow in the coil by the varying magnetic flux produced as permanent magnet 294 is rotated by the motor. Due to the speed at which permanent magnet 294 rotates, a relatively efficient magnetic flux coupling will exist between the permanent magnet and even an air coil type receiver coil (as opposed to receiver coil 414 as shown, which includes a core of a magnetically permeable material). Thus, flux generator base 280 is particularly well adapted to be used with air-cored receiver coils, as well as receiver coils having cores of magnetically permeable material.

By varying the speed at which the permanent magnet rotates, it is possible to control the magnitude of the current induced in the receiver coil. As the speed at which the permanent magnet rotates is increased, the magnitude of the electrical current produced by the receiver coil increases. It is contemplated that speed control knob 306 may be indexed to marks (not shown) that are provided on the exterior of housing 28 to indicate a range of electrical current for different settings of the speed control knob. Of course, the magnetic flux linkage can also be controlled by varying the separation between the flux generator base and the receiver coil.

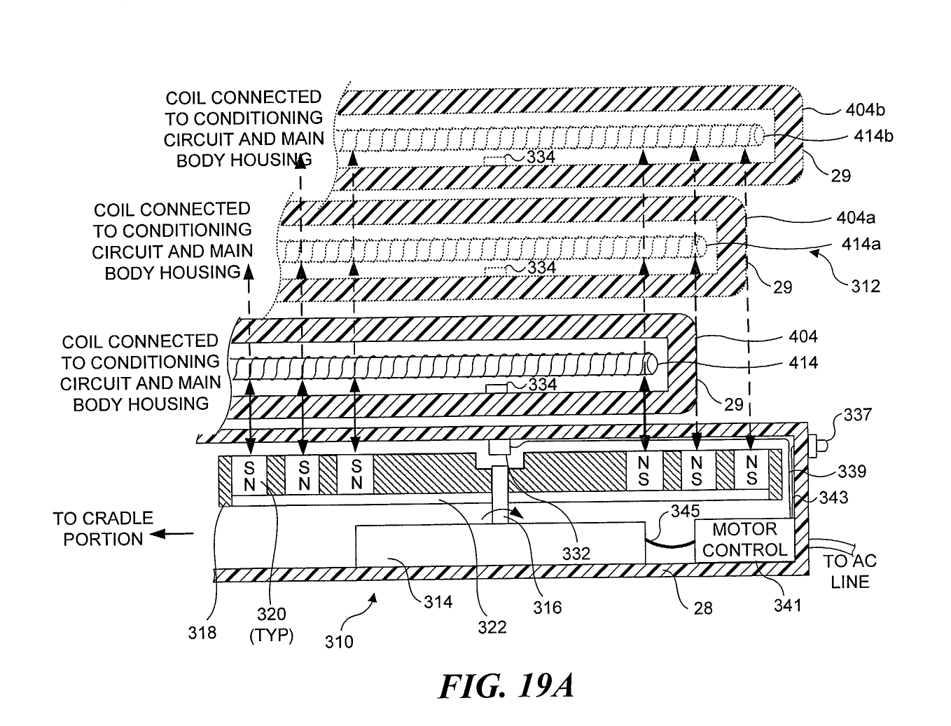

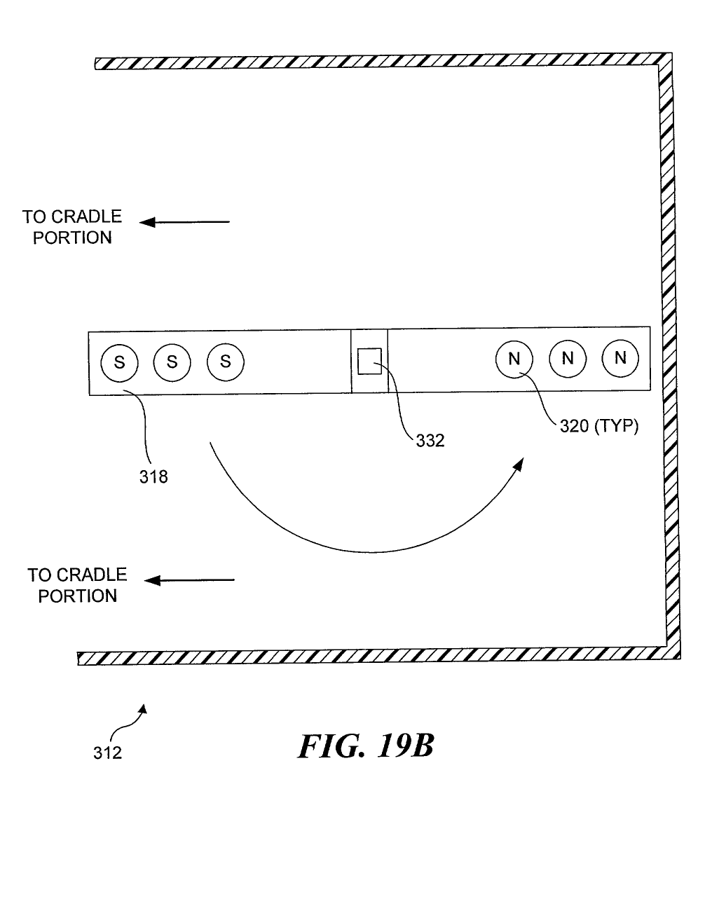

Another embodiment of the present invention suitable for use in supplying energy to a portable device is shown in FIGS. 19A and 19B. The apparatus comprises two primary components, a flux generator base unit 310, and a receiving unit 312. The flux generator base unit comprises a housing 28, a pancake electric motor 314 rotating a shaft 316, and a rotor 318. As noted above, housing 28 preferably includes both a charging portion (with an elongate depression generally corresponding to a size and shape of a receiver housing) and a cradle portion, such that the varying magnetic field is substantially directed toward the charging portion, and not toward the cradle portion. FIGS. 19A and 19B illustrate only the charging portion of housing 28. Similarly discussed above is that separate housing 29 (for the portable device to be recharged) including both a receiver housing, toward which the varying magnetic field is directed, and a main body portion, which receives little if any magnetic flux. Thus, FIGS. 19A and 19B illustrate only the receiver housing portion of housing 29.

As shown in FIG. 19B, preferably embedded in the rotor (or otherwise attached thereto) are a plurality of magnets 320. The magnets on one side of the rotor are oriented with their north pole faces on the upper side of the rotor, while the magnets on the opposite side of the rotor have their south pole faces on the upper side of the rotor. In addition, the magnets are arranged in pairs such that each pair comprises an upwardly facing north pole on one side and an upwardly facing south pole on the opposite side and the magnets on each pair are disposed at different radii from the shaft. The rotor also may include a flux linkage bar 322, that operates in a manner similar to that of the flux linkage bars described above. It is preferable that the components comprising the flux generator be of low profile so that the entire device is relatively wide and flat, giving the exterior shape of the base unit an overall appearance of a “tablet”, with the preferred depressions in the cradle section (adapted to engage the main body housing of a portable device) and in the charging portion (adapted to engage the receiver housing of a portable device).

The receiver housing may be either integrated into the main body housing of the portable device, or may comprise a separate housing that is attached to and adapted to engage the main body housing of the portable device. As noted above, the receiver housing preferably contains a receiver coil (comprising a magnetically permeable core and a conductive wire wound around the core) which is coupled to a conditioning circuit that is connected to the receiver coil via leads (see FIG. 2). It is preferable that the conditioning circuit be included in the main body housing of the portable device, as shown in FIG. 2. The magnetically permeable core of the receiver coil is sized so that the flux lines produced by the flux generator are optimally coupled with the core when the receiver unit is properly aligned with the charging portion of the flux generator base unit.

Note that the relative positions of permanent magnets 320 enable a variety of different receiver coils 414, 414a and 414b, each having different lengths (and encased in appropriately sized receiver housings 404, 404a, and 404b), to couple with at least one permanent magnet 320 (as indicated by force lines as shown) on each end of rotor 318, to enhance the coupling with the respective receiver coils. Note that generally only a single receiver coil will be coupled at any one time, and that when being recharged, receiver coils 414a and 414b would be positioned immediately adjacent to housing 28, as receiver coil 414 is positioned. This embodiment enables a single flux generator base unit to effectively couple with different portable devices, having receiver coils of differing lengths. While not shown, it should be understood that charging portion 410 (see FIG. 1B) can be sized such that receiver housings having different lengths can readily be accommodated.

As noted above, three different size receiver coils 414, 414a and 414b are shown in FIG. 19A to make clear that the flux generator base unit is universally usable with different size portable devices, having different size receiver coils. It should be clear from the above description that a receiver unit for a portable device would typically employ only one receiver coil. The use of three receiver coil core members shown in the figure is purely for illustrative purposes. Also, a flux generator in the base unit may comprise only one pair of magnets. If a plurality of pairs of magnets are included, the magnets of different pairs can be disposed at circumferentially spaced-apart locations and not just diametrically opposite each other as shown in the figure.

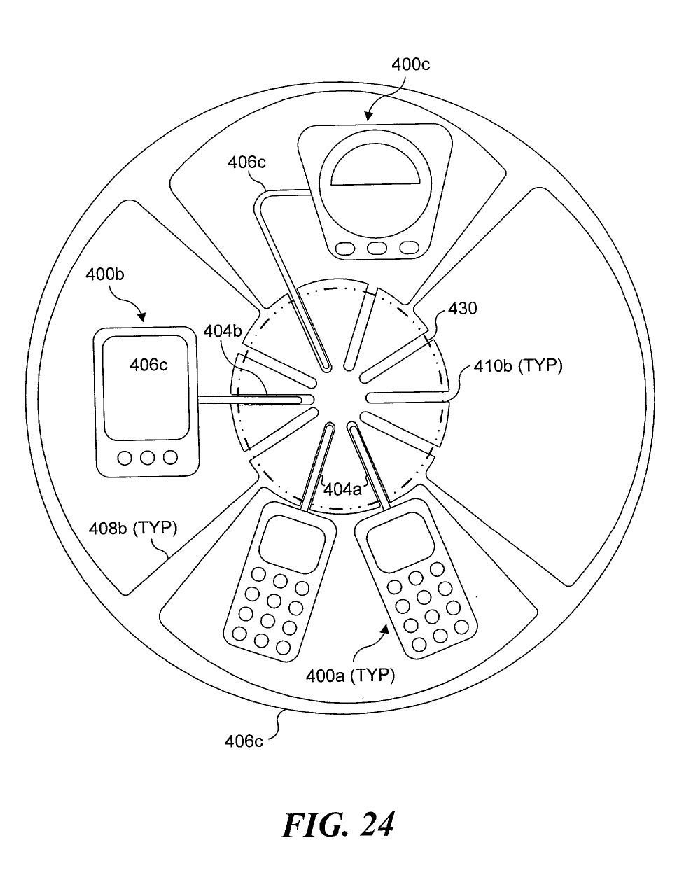

Note that FIG. 19A illustrates different size receiver coil portions of housing 29. It should be understood that the charging portion of base housing 28 (disposed immediately adjacent to the receiver coil portions of housing 29) will be of a size and shape capable of accommodating receiver coil portions of housing 29 of various sizes. Also, both base housing 28 and portable device housing 29 receiver coils have portions not shown in FIG. 19, i.e. the cradle portions and main body portions discussed above. It is likely that different portable devices, having different size receiver coil portions of housing 29, will have different size main body portions also. Thus, it is likely that base housing 29 of FIG. 19A will include a cradle portion that can accommodate various different size main body housings. FIG. 24, discussed in detail below, shows such an embodiment.

To save power and operational wear, it is desirable for the flux generator base unit to operate only when there is a load present (i.e., a battery to charge or electronic components that are energized by the base unit). When a load is not present, the base unit should preferably be in a low power consuming “sleep” mode. Therefore, it is desirable for the base unit to know when a load is present (so it can “wake up” and begin a charging or energy transfer operation) and to know when the battery is fully charged or the load is removed (so the base unit can turn off and go “back to sleep”).

This behavior can be accomplished in a variety of ways. For example, a Hall-effect sensor 332 (or reed switch) is mounted in the flux generator unit and a magnet 334 is disposed in the center of the receiver unit so that the magnet is in close proximity to the Hall-effect sensor (or reed switch) when the receiver unit is placed on the flux generator base unit. The magnetic field produced by magnet 334 is sensed by the Hall-effect sensor (or reed switch), causing a change in the output of the sensor. (The change of state in the output signal of the sensor will depend on whether the sensor includes a normally-open or normally-closed switch condition.) This sensor output signal is coupled through a lead 339 to a motor control 341 and enables the motor control to determine when a load is present so that it can wake up the base unit and energize the motor to produce a current in the receiver coil. In such circumstances, the motor will be with a current supplied through a lead 345 and the rotor will rotate, causing a variable magnetic field to be generated. Preferably, the Hall-effect sensor should be positioned in the center of the rotating magnetic field so that it is not significantly affected by it. Correspondingly, the receiver unit magnet should be disposed relative to the receiver and base units such that the receiver unit magnet and the Hall-effect sensor are in sufficiently close proximity to actuate the sensor only when the flux generator base unit and receiver unit are properly aligned and mated. It is preferable that when the Hall-effect sensor output changes state to indicate that the receiver unit has been properly positioned on the base unit, an indicator light 337 that is disposed in base unit will be energized with current supplied through a lead 343 by motor control 341. This same indicator light indicates that the base unit is in an operational mode (i.e., charging a battery). It is also contemplated that another indicator light 347 mounted on the receiver unit can be energized by the conditioning circuit when battery 327 in the receiver unit is fully charged, or conversely, the light can be extinguished when the battery is fully charged.

The conditioning circuit controls the current supplied for charging a battery and determines when the battery is fully charged. As discussed above, several vendors make suitable conditioning circuits for this purpose. When a battery charging cycle is complete, the energy consumed by the receiver unit from the flux generator base unit for battery charging will typically substantially decrease. This condition can be sensed in the flux generator by monitoring the current drawn by the electric motor. When the current is at a reduced level, the battery has either been fully charged or has been removed from the flux generator; in either case the flux generator motor can be turned off and go back to sleep.

In a more sophisticated feature of the apparatus, the receiver unit can communicate additional information (such as battery condition or status of the portable device, etc.) to the flux generator base unit for logging or display, by rapidly switching (i.e., pulsing) the current supplied by the conditioning circuit, thereby superimposing “digital” pulses relative to the load experienced by the electric motor in the flux generator base unit, causing corresponding pulses in the motor current due to the pulsed changes in the conditioning circuit load. The load on the motor will vary as a function of the energy being transferred to the receiver unit and consumed by the load, as controlled by the conditioning circuit. A rapid increase in load (even if only momentarily) can be “sensed” by a motor controller attempting to maintain a constant speed as a slowing of the rate at which the magnets are being rotated, which will require an increase in the motor current. Similarly, a rapid decrease in the load can be sensed by the motor controller, which must rapidly decrease the motor current to maintain a constant speed. The pulse fluctuation in the motor current due to the pulsing of the conditioning circuit load can thus be used to convey digital data between the receiver unit and the flux generator base unit. This pulse information evident in the motor current can then be decoded to interpret the data information provided from the receiver unit in the portable device, thereby effectively implementing a low-speed contactless communication channel from the portable device to the base unit. The information can be displayed at the base unit, or on a display (not shown) separate from the base unit. Optionally, the base unit could log the data passed to it from the portable device in an internal memory (not shown).

It is contemplated that the apparatus shown in FIGS. 19A and 19B could be adapted to be used with a variety of different-sized portable devices. For instance, by using a plurality of magnet pairs placed at different radii, various size receiver units could be used with a single “universal” base unit (that incorporates charger portions and cradle portions of relatively large size, as generally discussed above). It is further contemplated that one of three or four standard sizes of receiver units might be employed in most portable devices or used as a separate component relative to the portable device.

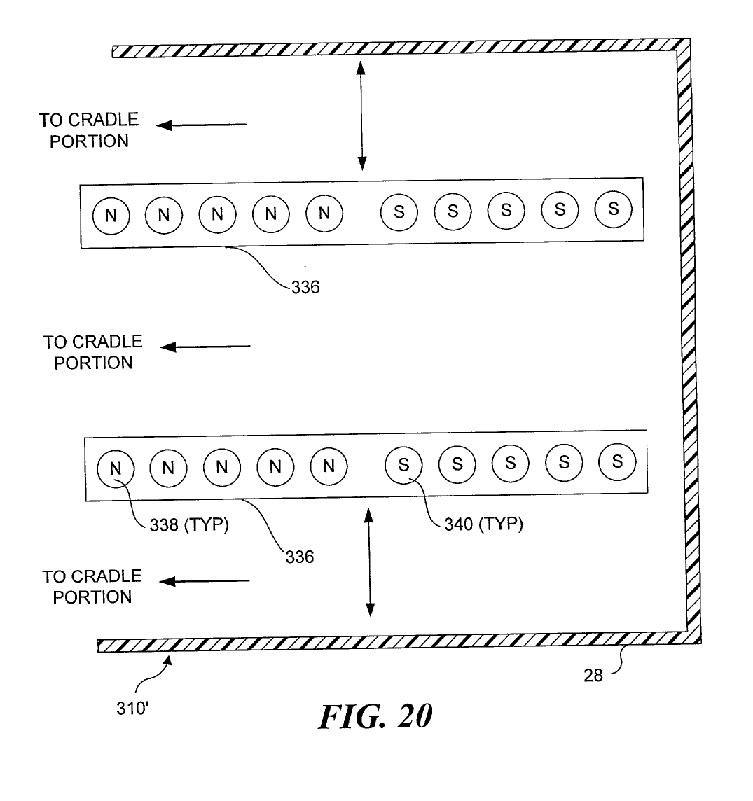

As discussed above, it is also possible to generate a variable magnetic field by using motions other than a rotary motion. For example, as shown in a flux generator base unit 310′ of FIG. 20, a linear motion could be applied to a pair of flux generator bars 336, each of which comprises a plurality of magnets 338 having north pole faces directed upwardly, and a plurality of magnets 340 with their south pole faces directed upwardly. As the flux generator bars are moved back and forth in a linear motion, a variable magnetic field is generated relative to a fixed magnetic receiver coil (not shown). The receiver coil can be of various sizes, so that its pole faces overlie different sets of permanent magnet poles. Although not shown, various well-known drive mechanisms could be used to provide the reciprocating linear motion driving the flux generator bars.

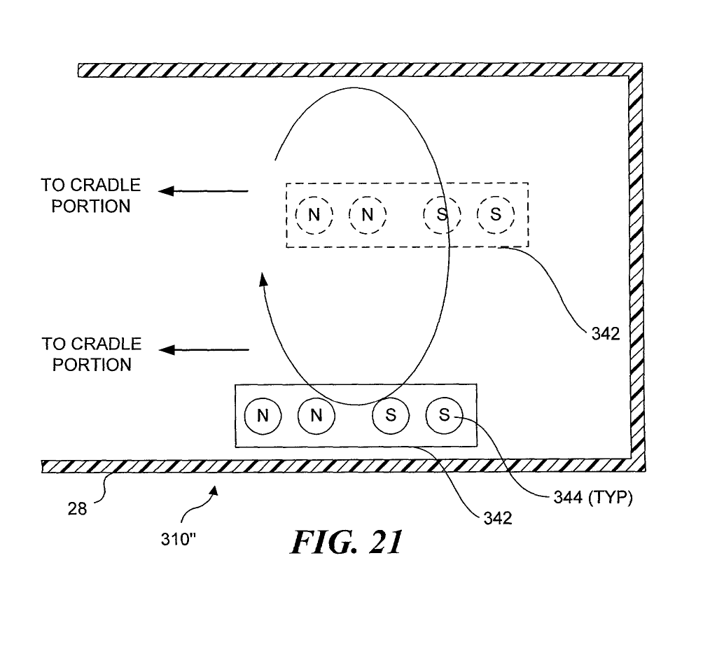

Another optional configuration comprising a flux generator base unit 310″ is shown in FIG. 21, wherein a pair of flux generator bars 342 comprising magnets 344 are driven in elliptical path so that the pole faces of the magnets move relative to a fixed receiver coil (not shown), varying the magnetic flux in the receiver coil.

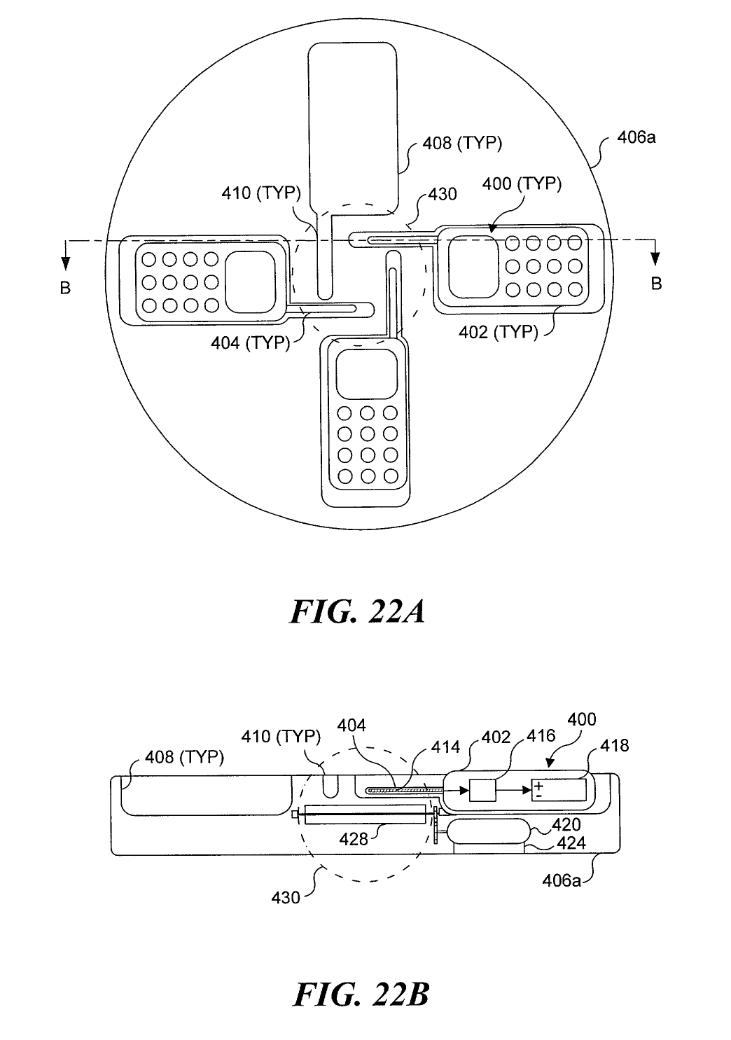

An embodiment of a base unit that enables a plurality of portable devices to be simultaneously charged or energized is shown in FIGS. 22A and 22B. A primary feature of the multiple charger base unit shown in these figures is that the magnetic flux is substantially confined toward the center portion of the base unit. The main body housings of the receiver units are disposed about the periphery of the base unit in cradle portions of the base unit housing, while the receiver housing portions of the receiver units are disposed in charger portions of the base unit housing, such that the receiver coils of the receiver units are adjacent to a central portion of the base unit housing. As can be seen in FIG. 22A, the magnetic flux is produced in the central core area of the base unit, such that substantially all of the magnetic flux is directed toward the charging portion of the base unit housing, and little magnetic flux is directed toward the cradle portion of the base unit housing, so that very little magnetic flux overlaps any of the main body housings of the receiver units.

The reference numbers of FIGS. 22A, 22B, 23 and 24 generally correspond to those used in FIGS. 1A, 1B and 2. Identical elements have the same reference numbers. FIG. 22A is a plan view showing several portable electronic devices 400 placed into a charging base unit 406a that includes a plurality of cradle portions 408, each cradle portion being associated with a different charging portion 410. As before, cradle portions 408 are of a size and shape suitable to provide support for main body housing 402 of portable devices 400, and charging portions 410 are similarly of a size and shape suitable to receive elongate receiver housing 404 of portable devices 400. As noted above, it is important that elongate receiver housing 404 be properly positioned relative to charging portion 410, to ensure that the varying magnetic field produced adjacent to charging portions 410 (see area 430) couples with each receiver coil disposed within elongate receiver housings 404.

FIG. 22B illustrates receiving coil 414 disposed within elongate receiver housing 404. As noted above, receiving coil 414 is preferably coupled to circuit 416, which controls, rectifies, filters, and/or conditions the electrical current before it is supplied to recharge rechargeable battery 418. Conditioning circuits that are suitable for use in the present invention have been described above. Charging base unit 406a includes electric motor 420 mounted on support 424, and the drive gears, shaft and support bearings as previously described. Preferably, electric motor 420 is energized by an external power source, such as a household electrical line voltage outlet (not separately shown). The drive train described above rotates permanent magnet structure 428, causing lines of varying magnetic flux to intersect the receiving coils disposed in charging portions 410, thus inducing a current in each receiving coil that recharges each battery 418 in the portable devices.

Note that area 430 encompasses the limits of a magnetic field that passes through receiving coil 414 disposed in an individual charging portion 410, but very little of main body housing 402 of each portable device. Thus, a single motor that is useable for providing the driving force needed for charging a single portable device in FIG. 2, is capable of charging up to four portable devices in the embodiment of FIGS. 22A and 22B. Furthermore, the number of charging portions is a matter of design choice for a particular base unit housing, and it should be understood that four charging portions does not represent a maximum number of possible charging portions. As long as the varying magnetic field provided is sufficient, additional charging portions can be included on the base unit.

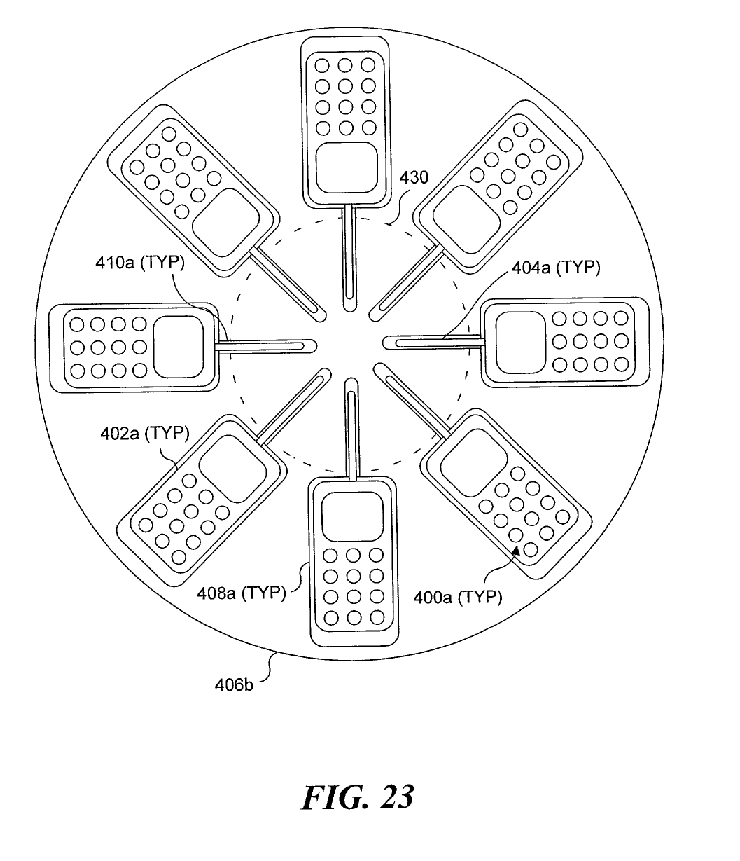

FIG. 23 shows an embodiment in which a base unit housing 406b includes eight cradle portions 408a and eight charging portions 410a. Note that the position of each charging portion 410a has been changed relative to each cradle portion, such that the charging portion is substantially disposed in line with a center axis of each cradle portion. This configuration enables more charging portions to be disposed within a center core of base unit housing 406b (as compared with base unit housing 406a). Of course, each receiver housing 404a must be positioned about a central axis of each portable device 400a. Again, the magnetic flux (see area 430) is substantially confined toward the center portion of the base unit. The main body housings of the receiver units are disposed about the periphery of the base unit in cradle portions of the base unit housing, while the receiver housing portions of the receiver units are disposed in charger portions of the base unit housing, such that the receiver coils of the receiver units are adjacent to a central portion of the base unit housing. Substantially all of the magnetic flux is directed toward the charging portion of the base unit housing, and little magnetic flux is directed toward the cradle portion of the base unit housing so that very little magnetic flux overlaps any of the main body housings of the receiver units.

As shown in FIGS. 22A and 23, each cradle portion of the respective base unit housings are of the same size and shape. However, it is contemplated that a single base unit housing can comprise a plurality of different size and shape cradle portions and charging portions, so that different types of portable devices (receiver units) can be recharged simultaneously. FIG. 24 illustrates such an embodiment. Base unit housing 406c includes four cradle portions 408b, whose size and shape is substantially larger than that of the previously illustrated cradle portions. In this embodiment, the size and shape of each cradle portion is not matched to a particular portable device to enable a plurality of different size and shape portable devices to be charged or energized using base unit housing 406c. It should be understood that more or less than four cradle portions could be incorporated into such a base unit, and that each cradle unit can be of a different size and shape. Note also that each cradle portion 408b is associated with more than one charging portion 410b to enable a variety of different portable device/receiver housing configurations to be accommodated. For example, in one cradle portion 408b, two portable devices 400a are disposed, each having receiver housing 404a disposed in a different charging portion 410b. In another cradle portion 408b, a different portable device 400b (such as a personal digital assistant) has a receiver housing 404b extending from a side of the portable device. Receiver housing 404b is placed into the charging portion of the respective cradle portion that most readily or conveniently accommodates the size, shape, and receiver housing configuration of portable device 400b. In yet another cradle portion 408b, a still different portable device 400c (such as a personal compact disc player) has a receiver housing 404c extending from a side of the portable device. Receiver housing 404c is particularly flexible, enabling receiver housing 404c to be flexed as required to enable it to be disposed within a charging portion associated with the cradle portion into which portable device 400c has been placed. As before, the magnetic flux generated is concentrated toward the charging portion (the central core of base unit housing 406c (see area 430)) and substantially away from the cradle portions of the base unit housing.

Because the cradle portions of base unit housing 406c are not sized and shaped to accommodate particular portable devices, it is preferable for each charging portion 410b to include gripping means (such as gripping means 412 of FIG. 1B) to ensure that the receiver housing disposed in that charging portion is properly positioned to receive the varying magnetic flux. It has been noted that a suitable gripping means is an elastomeric material forming a bead that releasably grips a receiver housing in an interference fit. While not specifically shown, it is anticipated that base unit housing 406c can beneficially include charging portions (such as charging portion 410b) that have different shapes and sizes, to accommodate a variety of different sizes and shapes of receiver housings.

Although the present invention has been described in connection with the preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A contactless electrical energy transfer apparatus comprising:
(a) a portable receiving unit including:
(i) a receiver coil; and
(ii) a housing in which the receiver coil is disposed, said housing supporting the receiver coil and extending outwardly from a main body of said portable receiving unit, such that said housing and receiver coil are substantially separated from said main body; and
(b) a flux generator including:
(i) a base adapted to be disposed proximate to the receiving unit, said base comprising a cradle section and a charging section, said charging section being adapted to receive said housing in which the receiver coil is disposed;
(ii) a magnetic field generator comprising at least one permanent magnet disposed within the base; and
(iii) a prime mover drivingly coupled to an element of the magnetic field generator, causing said element of the magnetic field generator to move relative to the receiver coil, movement of said element of the magnetic field generator producing a varying magnetic field that is coupled to the receiver coil, inducing an electrical current to flow in the receiver coil.

2. The energy transfer apparatus of claim 1, wherein said cradle portion has a size and shape generally corresponding to said main body.

3. The energy transfer apparatus of claim 1, wherein said charging portion includes a receptacle having a size and shape generally corresponding to said housing of the receiver coil.

4. The energy transfer apparatus of claim 1, wherein said charging portion includes gripping means for retaining said housing in a desired position.

5. The energy transfer apparatus of claim 4, wherein said gripping means comprises an elastomeric material.

6. The energy transfer apparatus of claim 1, further comprising a plurality of cradle portions and a plurality of charging portions.

7. The energy transfer apparatus of claim 6, wherein each cradle portion is associated with a different charging portion.

8. The energy transfer apparatus of claim 7, wherein each charging portion is disposed about a central axis of an associated cradle portion.

9. The energy transfer apparatus of claim 7, wherein each charging portion is offset from a central axis of an associated cradle portion.

10. The energy transfer apparatus of claim 6, wherein each cradle portion is associated with a plurality of charging portions.

11. The energy transfer apparatus of claim 6, wherein said plurality of cradle portions are disposed adjacent to a periphery of said base, and said plurality of charging portions are disposed adjacent to a central core of said base.

12. The energy transfer apparatus of claim 6, wherein said magnetic field generator directs a magnetic flux generally toward a central core of said base and away from a periphery of said base.

13. The energy transfer apparatus of claim 6, wherein at least one cradle portion is substantially larger in size than said portable receiving unit, such that a different portable receiving unit, having a different size and shape than said portable receiving unit, can be accommodated by said at least one cradle portion.

14. The energy transfer apparatus of claim 1, wherein said housing and said receiver coil are substantially flexible, enabling said housing and said receiver coil to be substantially flexed when received into said charging portion.

15. The energy transfer apparatus of claim 1, wherein said housing comprises an antenna.

16. The energy transfer apparatus of claim 15, wherein said receiver coil is also adapted for receiving radio frequency signals.

17. The energy transfer apparatus of claim 1, further comprising a rechargeable battery disposed within the main body of said portable receiving unit, said receiver coil being electrically coupled to recharge the rechargeable battery.

18. The energy transfer apparatus of claim 1, wherein said varying magnetic field produced by said magnetic field generator magnetic field generator is substantially weaker at said main body than at said receiver coil.

19. The energy transfer apparatus of claim 1, wherein the prime mover is disposed within the base of the flux generator.

20. The energy transfer apparatus of claim 1, wherein the prime mover comprises an electric motor.

21. The energy transfer apparatus of claim 1, wherein the prime mover is disposed outside the housing of the magnetic field generator and is drivingly coupled to said element of the magnetic field generator through a driven shaft.

22. The energy transfer apparatus of claim 1, wherein said at least one permanent magnet is moved by the prime mover.

23. The energy transfer apparatus of claim 1, wherein said at least one permanent magnet comprises a rare earth alloy.

24. The energy transfer apparatus of claim 1, wherein the magnetic field generator includes a plurality of permanent magnets and a support on which the plurality of permanent magnets are mounted, said prime mover causing the support to move, thereby varying the magnetic field along a path that includes the receiver coil.

25. The energy transfer apparatus of claim 24, wherein the support is caused to move reciprocally back and forth in a reciprocating motion.

26. The energy transfer apparatus of claim 1, wherein the element of the magnetic field generator that is drivingly coupled to the prime mover comprises a magnetic flux shunt that is moved by the prime mover, to periodically shunt a magnetic field produced by said at least one permanent magnet of the magnetic field generator, causing the magnetic field to vary along a path that includes the receiver coil.

27. The energy transfer apparatus of claim 1, further comprising an adjustment member that is selectively actuatable to change a maximum magnetic flux that is coupled to the receiver coil.

28. The energy transfer apparatus of claim 27, wherein the adjustment member controls a speed with which the element of the magnetic field generator is moved.

29. The energy transfer apparatus of claim 1, wherein the magnetic field generator includes a plurality of permanent magnets mounted to the element at radially spaced-apart points around a central axis, enabling the varying magnetic field produced by magnetic field generator to couple with a plurality of different size receiver coils.

30. The energy transfer apparatus of claim 29, wherein the prime mover rotates the element and the plurality of permanent magnets about the central axis.

31. A contactless electrical energy transfer apparatus adapted to couple magnetic energy into a portable device having a main body and a magnetic energy receiving portion, comprising:
(a) a base adapted to be disposed proximate to the magnetic energy receiving portion, said base comprising a cradle section and a charging section, said cradle section being adapted to support said main body, and said charging section being adapted to receive said magnetic energy receiving portion of the portable device;
(b) a prime mover; and
(c) a magnetic field generator that is disposed within the base, said magnetic field generator comprising a permanent magnet and including an element that is moved by the prime mover, causing a varying magnetic field to be produced for coupling with the magnetic energy receiving portion of the portable device, the varying magnetic field being substantially excluded from the main body portion of the portable device.

32. The energy transfer apparatus of claim 31, wherein said cradle section has a size and shape generally corresponding to that of said main body portion.

33. The energy transfer apparatus of claim 31, wherein said charging section has a slot with a size and shape generally corresponding to that of said magnetic energy receiving portion.

34. The energy transfer apparatus of claim 31, wherein said charging section is of a size sufficient to provide an interference fit that retains said magnetic energy receiving portion in a desired position.

35. The energy transfer apparatus of claim 34, wherein said charging section comprises elastomeric gripping means for providing the interference fit.

36. The energy transfer apparatus of claim 31, further comprising a plurality of cradle sections and a plurality of charging sections.

37. The energy transfer apparatus of claim 36, wherein each cradle section is associated with a different charging section.

38. The energy transfer apparatus of claim 37, wherein each charging section is disposed in alignment with a central axis of an associated cradle section.

39. The energy transfer apparatus of claim 37, wherein each charging section is offset from a central axis of an associated cradle section.

40. The energy transfer apparatus of claim 36, wherein each cradle section is associated with a plurality of charging section.

41. The energy transfer apparatus of claim 36, wherein said plurality of cradle sections are disposed adjacent to a periphery of said base, and said plurality of charging sections are disposed adjacent to a central core of said base.

42. The energy transfer apparatus of claim 36, wherein said magnetic field generator directs a magnetic flux substantially toward a central core of said base, and away from a periphery of said base.

43. The energy transfer apparatus of claim 36, wherein at least one cradle portion is substantially larger in size than said portable device, such that a different portable device, having a different size and shape than said portable device, can be accommodated by said at least one cradle portion.

44. Contactless electrical energy transfer apparatus comprising:
(a) a portable device that includes:
(i) a receiver coil disposed in a receiver housing; and
(ii) a main housing in which electronic components of the portable device are disposed, said receiver housing extending outwardly from said main housing such that said receiver housing and receiver coil are substantially distinct from said main housing; and
(b) a flux generator including:
(i) a base adapted to be disposed proximate to the portable device, said base comprising a cradle section and a charging section, said cradle section receiving said main housing and said charging section receiving said receiver housing when the portable device is receiving energy;
(ii) a magnetic field generator disposed within the base for the flux generator and comprising at least one permanent magnet and a flux shunt, said at least one permanent magnet being fixed relative to the receiver coil; and
(iii) a prime mover that is drivingly coupled to said flux shunt, said flux shunt being moved by the prime mover, to intermittently pass adjacent to pole faces of said at least one permanent magnet so as to provide a magnetic flux shunt path between the pole faces, thereby varying a magnetic field experienced by the receiver coil, inducing an electrical current to flow in the receiver coil, said varying magnetic field being generally directed away from said main housing.

45. The energy transfer apparatus of claim 48, wherein said charging section comprises means for gripping said receiver coil.

46. The energy transfer apparatus of claim 48, further comprising a plurality of cradle sections and a plurality of charging sections, each cradle section being associated with at least one charging section, said plurality of charging sections being disposed adjacent a central core of said base.

47. A contactless electrical energy transfer apparatus that supplies electrical energy to a portable device, where the portable device includes a receiver coil attached to a main housing, comprising:
(a) a charging base that is adapted to be disposed proximate to the portable device, said charging base having a charging section and being adapted to support the portable device with said charging section positioned proximate to the receiver coil of the portable device;
(b) a magnetic field generator disposed within the charging base, said magnetic field generator including a permanent magnet having opposite pole faces, and a flux shunt that is movably supported within the charging base;
(c) a prime mover that is drivingly coupled to the flux shunt, causing the flux shunt to move and intermittently pass adjacent to the opposite pole faces of said permanent magnet so as to provide a magnetic flux shunt path between the pole faces, thereby producing a varying magnetic field that is coupled with the receiver coil of the portable device, the varying magnetic field inducing an electrical current to flow in the receiving coil for use in energizing the portable device, said charging base being configured to direct the varying magnetic field toward the receiver coil of the portable device, and away from the main housing of the portable device.

48. The energy transfer apparatus of claim 51, wherein the flux shunt comprises a bar of magnetically permeable material that extends over the opposite pole faces of the permanent magnet in at least one orientation, as the flux shunt is moved by the prime mover.

49. The energy transfer apparatus of claim 51, wherein the magnetic field generator includes a plurality of permanent magnets, and a fixed flux linkage bar coupling magnetic flux between different pole faces of the plurality of permanent magnets, said flux shunt periodically being moved over opposite pole faces of the plurality of permanent magnets to produce the varying magnetic field.

50. A contactless battery charging and energy transfer apparatus, comprising:
(a) a flux generating base unit that includes:
(i) an electric motor having a drive shaft;
(ii) magnetic structure, operatively coupled to the drive shaft of the electric motor and drivingly rotated thereby, said magnetic structure a plurality of permanent magnets, each permanent magnet having a north pole face and a south pole face oriented generally parallel to a rotational plane of the magnetic structure; and
(iii) a housing in which the electric motor and magnetic structure are disposed, a surface of the housing defining a contactless mounting interface;
(b) a receiving unit that includes:
(i) an electrical energy-consuming load;
(ii) a main housing in which said electrical energy-consuming load is disposed; and
(iii) a receiver coil having a core formed of a magnetically permeable material and an electrically conductive winding wound around the core, said receiver coil being adapted to be placed proximate the contactless mounting interface, said receiver coil extending outwardly and away from said main housing, such that a varying magnetic field produced by the flux generating base unit and directed toward said receiver coil is generally not experienced by the main housing of the receiving unit, thereby preventing said electrical energy-consuming load from being affected by the varying magnetic field; and
(c) a conditioning circuit electrically connected to the winding of the receiver coil, wherein a rotation of the magnetic structure by the electric motor causes the receiver coil to experience a varying magnetic field, inducing an electrical current to flow in said winding, said electrical current being conditioned by the conditioning circuit for use in supplying electrical energy to the load.

51. The contactless battery charging and energy transfer apparatus of claim 50, wherein the load in the receiving unit comprises a rechargeable storage battery.

52. The contactless battery charging and energy transfer apparatus of claim 50, wherein the receiving coil and the contactless mounting interface of the flux generator base unit are elongate in shape.

53. The contactless battery charging and energy transfer apparatus of claim 51, further comprising a sensor that produces a signal indicative of whether the receiving coil is properly mated with the contactless mounting interface of the flux generating base unit.

54. The contactless battery charging and energy transfer apparatus of claim 53, wherein the sensor comprises one of a Hall-effect sensor and a reed switch disposed within the housing of the flux generator base unit, the signal being produced by the sensor in response to a magnetic field produced by a permanent magnet included with the receiving unit when the receiving coil is properly mated with the contactless mounting interface of the flux generating base unit.

55. The contactless battery charging and energy transfer apparatus of claim 53, wherein the electric motor is energized in response to the signal produced by the sensor, so that the magnetic structure only rotates when the receiving coil is properly mated with the contactless mounting interface of the flux generating base unit.

56. The contactless battery charging and energy transfer apparatus of claim 55, further comprising an indicator that indicates when the rechargeable storage battery connected to the output of the conditioning circuit is fully charged.

57. The contactless battery charging and energy transfer apparatus of claim 55, wherein the conditioning circuit in the receiving unit detects when the rechargeable storage battery connected to the output of the conditioning circuit is fully charged and reduces the electrical current supplied to the rechargeable storage battery upon detecting such a condition.

58. The contactless battery charging and energy transfer apparatus of claim 50, wherein the flux generator base unit comprises a sensor for determining when a battery connected to the output of the conditioning circuit is fully charged, and upon detecting such a condition, causes the electric motor to be de-energized.

59. The contactless battery charging and energy transfer apparatus of claim 50, wherein the housing of the flux generator base unit is stepped, defining a plurality of cradles adapted to mate with respective main housings of receiving units of varying sizes.

60. The contactless battery charging and energy transfer apparatus of claim 54, further comprising a motor control that supplies electrical current to the electrical motor and controls a rotational speed of the magnetic structure, said motor control monitoring the current supplied to the electrical motor.

61. A method for charging a battery by inductively coupling a varying magnetic field produced in a first portion of a base component to a receiver coil disposed in a first portion of a receiver component, without interfering with electronic components disposed in a second portion of the receiver component, comprising the steps of:
(a) positioning the first portion of the receiver component proximate the first portion of the base component;
(b) positioning the second portion of the receiver component proximate a second portion of the base component; such that the second portion of the base component substantially supports the second portion of the receiver component, and such that the first portion of the receiver component and the second portion of the receiver component do not substantially overlap;
(c) generating a magnetic field with a permanent magnet disposed in the first portion of the base component;
(d) coupling a driving force to an element in the base component so that the element is movable;
(e) moving the element with the driving force to produce a varying magnetic field, the varying magnetic field being inductively coupled to the receiver coil disposed within the first portion of the receiver component and inducing a corresponding electrical current in the receiver coil;
(f) conditioning the electrical current to produce a conditioned current at a voltage suitable for charging a battery; and
(g) charging the battery with the conditioned current.

62. The method of claim 61, wherein a source of the driving force is disposed remote from where the magnetic field is generated by the permanent magnet and is coupled to the element through a driven shaft.

63. The method of claim 61, wherein the magnetic field is generated by a plurality of permanent magnets.

64. The method of claim 61, wherein the element that is moved comprises said permanent magnet.

65. The method of claim 64, wherein the step of moving the element comprises the step of rotating the permanent magnet to vary a magnetic flux produced by the permanent magnet along a path that includes the receiver coil.

66. The method of claim 64, wherein the step of moving the element comprises the step of reciprocating the permanent magnet back and forth to vary a magnetic flux along a path that includes the receiver coil.

67. The method of claim 61, further comprising the step of enhancing a magnetic flux linkage between magnetic poles of the permanent magnet and the receiver coil.

68. The method of claim 67, wherein the step of enhancing the magnetic flux linkage comprises the step of providing a flux linkage bar for coupling a magnetic field from a pole of the permanent magnet into the receiver coil.

69. The method of claim 61, further comprising the step of selectively varying a maximum magnetic field intensity coupled with the receiver coil.

70. The method of claim 69, wherein the step of selectively varying the maximum magnetic field intensity comprises the step of varying a position of the permanent magnet relative to the receiver coil to control the magnetic field coupled to the receiver coil.

71. The method of claim 69, wherein the step of selectively varying the maximum magnetic field intensity comprises the step of changing a speed with which the element moves.

72. The method of claim 61, wherein the magnetic field is generated with a plurality of permanent magnets, and wherein the moving element comprises the plurality of permanent magnets, further comprising the step of moving one of the permanent magnets, and magnetically coupling another of the plurality of permanent magnets to the permanent magnet that is moved, so that another of the plurality of permanent magnets is moved thereby.

73. The method of claim 61, wherein the magnetic field is generated with a plurality of permanent magnets that are fixed, and wherein the step of moving the element comprises the step of intermittently passing a flux shunt member adjacent to pole faces of the plurality of permanent magnets so as to provide a magnetic flux shunt path between the pole faces of the plurality of permanent magnets, to produce the varying magnetic field.

74. The method of claim 73, wherein the plurality of permanent magnets are moved laterally back and forth past the receiver coil to vary the magnetic field.

75. The method of claim 73, wherein the plurality of permanent magnets are radially movable on a support that is rotated to produce the varying magnetic field, further comprising the steps of:
(a) forcing the plurality of permanent magnets toward each other when the support is at rest to reduce a startup torque required to begin rotating the support; and
(b) adjusting a separation between the plurality of permanent magnets when the support is rotated, to change a magnitude of the magnetic field coupled to the receiver coil.

76. The method of claim 69, wherein the step of selectively varying the maximum magnetic field intensity comprises the steps of:
(a) providing a plurality of turns of a conductor wound around said permanent magnet; and
(b) causing an electrical current to flow through the plurality of turns of the conductor to selectively adjust a maximum value of the magnetic field produced by said permanent magnet, said electrical current producing a magnetic field that either increases or reduces the magnetic field generated by the permanent magnet.

77. The method of claim 61, further comprising the step of providing an indication of whether the battery is being charged by the conditioned current.

78. The method of claim 61, further comprising the step of providing an indication of whether the battery is fully charged.

79. The method of claim 61, wherein the first portion of the receiver component extends outwardly from the second portion of the receiver component.

80. The method of claim 79, wherein the first portion of the receiver component comprises an antenna.

81. The method of claim 65, wherein the receiver component comprises a portable device.
